(19) United States
(12) Patent Application Publication
(10) Pub. No.: US 2026/0039325 A1
(43) Pub. Date: Feb. 5, 2026

(54) ELECTRONIC DEVICE INCLUDING TUNING CIRCUIT AND METHOD OF CONTROLLING THE TUNING CIRCUIT

(71) Applicant: SAMSUNG ELECTRONICS CO., LTD., Suwon-si (KR)

(72) Inventors: Min-Gi Kim, Suwon-si (KR); Sumin Kim, Suwon-si (KR); Sangmi Noh, Suwon-si (KR); Hyung Sun Lim, Suwon-si (KR); Dooseok Choi, Suwon-si (KR); Joonhoi Hur, Suwon-si (KR)

(21) Appl. No.: 19/185,549

(22) Filed: Apr. 22, 2025

(30) Foreign Application Priority Data
Jul. 31, 2024 (KR) 10-2024-0102131

(51) Int. Cl. H04B 1/40

(52) U.S. Cl. CPC H04B 1/40

(57) ABSTRACT

An electronic device includes an antenna, a tuning circuit connected to the antenna and including a plurality of elements, and a processor controlling the tuning circuit using a tune code having a plurality of bits, respectively corresponding to the plurality of elements. The processor may identify a plurality of valid tune codes from among tune codes having different values, based on the elements, the valid tune codes satisfying a predetermined default rule for at least a portion of the bits, identify first band tune codes from among the valid tune codes, the first band codes satisfying a first band rule set for bits corresponding to at least one capacitor array, and control the tuning circuit using one of the first band tune codes when the electronic device transmits and/or receives a signal of a first frequency band. The processor applies other tune codes in at least one other frequency band.

### CROSS-REFERENCE TO RELATED APPLICATION(S)

This U.S. non-provisional application claims priority under 35 USC § 119 to Korean Patent Application No. 10-2024-0102131, filed on Jul. 31, 2024, in the Korean Intellectual Property Office, the disclosure of which is herein incorporated by reference in its entirety.

### TECHNICAL FIELD

This disclosure relates to an electronic device including a tuning circuit and more particularly a method of using tune codes to control a tuning circuit connected to an antenna.

### DISCUSSION OF RELATED ART

As mobile communication technology has evolved, electronic devices with antennas, such as smartphones and wearable devices, have become commonplace. Such electronic devices may transmit and receive various types of data (for example, messages, photos, videos, music files, games, or the like) through antennas.

In an electronic device, antenna performance has a significant impact on the efficiency of wireless signal transmission. Antenna performance may be subject to constant change depending on the usage environment of an electronic device such as a wireless terminal (e.g., a smartphone). For example, a metal-cased terminal may experience impedance mismatch arising from external environmental changes such as hand-grip pressure, USB usage, or earphone jack connection. This may cause a resonant frequency of an antenna to shift, resulting in lower output efficiency at a desired frequency.

Accordingly, a tuning process of measuring antenna impedance in real time and compensating for impedance mismatch and resonant frequency has been attempted to improve antenna performance.

A method of controlling the antenna impedance by controlling the tuning circuit connected to the antenna has been used to perform such a tuning process. For example, a method of controlling impedance of an electrical path connected to an antenna may involve controlling a plurality of tuning elements included in the tuning circuit using tune codes applied from a processor.

### SUMMARY

Example embodiments provide an electronic device for reducing time and costs required to select effective tune codes for a tuning circuit depending on frequency.

According to an example embodiment, an electronic device includes an antenna configured to transmit and/or receive a radio-frequency (RF) signal, a tuning circuit connected to the antenna and including a plurality of elements, and a processor configured to control the tuning circuit using a tune code comprising a plurality of bits, respectively corresponding to the plurality of elements. The processor may be configured to identify a plurality of valid tune codes from among a plurality of tune codes having different values, based on information related to the plurality of elements, the plurality of valid tune codes satisfying a predetermined default rule for at least a portion of the plurality of bits, identify a plurality of first band tune codes from among the plurality of valid tune codes, the plurality of first band codes satisfying a first band rule set for bits corresponding to at least one capacitor array, and control the tuning circuit using one of the plurality of first band tune codes when the electronic device transmits and/or receives a signal of a first frequency band. The first frequency band is different from at least one other frequency band at which the processor controls the tuning circuit using different ones of the identified valid tune codes.

According to an example embodiment, a method of controlling a tuning circuit includes generating a plurality of tune codes, each comprising a plurality of bits corresponding to a plurality of elements included in the tuning circuit, based on a number of the plurality of elements, identifying a plurality of valid tune codes satisfying a default rule set for at least some of the plurality of bits from among the plurality of tune codes, identifying a plurality of first band tune codes satisfying a first band rule set for bits corresponding to at least one capacitor array from among the plurality of valid tune codes, and controlling the tuning circuit using one of the plurality of first band tune codes when a signal of a first frequency band is transmitted and/or received through an antenna. The first frequency band is different from at least one other frequency band at which the tuning circuit operates using different ones of the identified valid tune codes.

According to an example embodiment, an antenna device includes a tuning circuit, including a plurality of elements, and a processor configured to control the tuning circuit using a tune code comprising a plurality of bits, respectively corresponding to the plurality of elements. The processor may be configured to identify a plurality of valid tune codes satisfying a default rule set for at least a portion of the plurality of bits from among a plurality of tune codes having different values, based on information related to the plurality of elements and control the tuning circuit using one of the plurality of valid tune codes.

### BRIEF DESCRIPTION OF DRAWINGS

FIG. 1 is a block diagram of an electronic device according to an example embodiment.

FIG. 2A is a circuit diagram of a tuning circuit according to an example embodiment.

FIG. 2B is a circuit diagram illustrating a first capacitor array in the tuning circuit in FIG. 2A.

FIG. 3 is a diagram illustrating a tune code including bits corresponding to a plurality of elements included in a tuning circuit according to an example embodiment.

FIG. 4 is a diagram illustrating a plurality of tune codes generated from information related to a plurality of elements according to an example embodiment.

FIG. 5 is a diagram illustrating a plurality of valid tune codes satisfying basic rules, among a plurality of tune codes according to an example embodiment.

FIG. 6A is a diagram illustrating a plurality of first band tune codes satisfying a first band rule, among a plurality of valid tune codes according to an example embodiment.

FIG. 6B is a diagram illustrating a plurality of second band tune codes satisfying a second band rule, among a plurality of valid tune codes according to an example embodiment.

FIG. 6C is a diagram illustrating a plurality of third band tune codes satisfying a third band rule, among a plurality of valid tune codes according to an example embodiment.

FIG. 7 is a circuit diagram of a tuning circuit according to an example embodiment.

FIG. 8A is a diagram illustrating a tune code including bits corresponding to a plurality of elements included in a tuning circuit according to an example embodiment.

FIG. 8B is a diagram illustrating a configuration to identify band tune codes of each frequency band from a plurality of valid tune codes according to an example embodiment.

FIG. 9 is a circuit diagram illustrating a tuning circuit according to an example embodiment.

FIG. 10A is a diagram illustrating a tune code including bits corresponding to a plurality of elements included in a tuning circuit according to an example embodiment.

FIG. 10B is a diagram illustrating a configuration to identify band tune codes of each frequency band from a plurality of tune codes according to an example embodiment.

FIG. 11 is a circuit diagram of a tuning circuit according to an example embodiment.

FIG. 12A is a diagram illustrating a tune code including bits corresponding to a plurality of elements included in a tuning circuit according to an example embodiment.

FIG. 12B is a diagram illustrating a configuration to identify band tune codes of each frequency band from a plurality of tune codes according to an example embodiment.

FIG. 13 is a diagram illustrating an electronic device further including a coupler according to an embodiment.

FIG. 14 is a flowchart illustrating a method for controlling a tuning circuit according to an example embodiment.

FIG. 15 is a flowchart illustrating a method of controlling a tuning circuit based on a plurality of second band tune codes valid for a second frequency according to an example embodiment.

FIG. 16 is a block diagram of an electronic device according to an example embodiment.

FIG. 17 is a block diagram of an IoT device including an electronic device according to an example embodiment.

FIG. 18 is a block diagram of a mobile terminal to which an electronic device according to an example embodiment is applied.

### DETAILED DESCRIPTION

Hereinafter, example embodiments will be described with reference to the accompanying drawings.

The term “first,” “second,” or the like used herein may modify various elements regardless of the order and/or priority thereof, and is used only for distinguishing one element from another element, without limiting example embodiments.

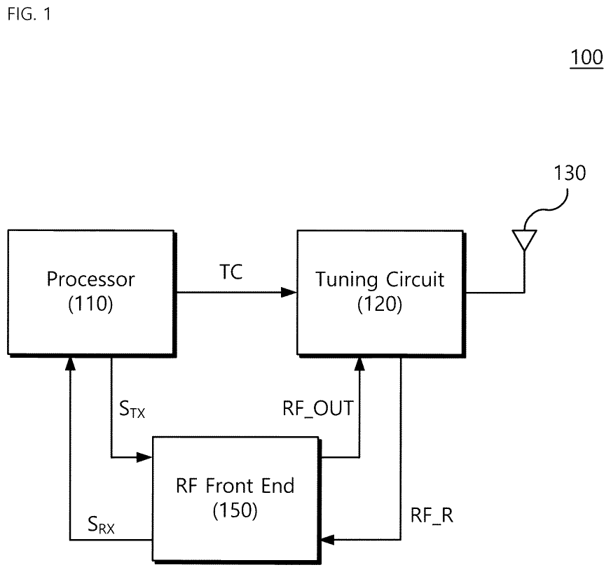

FIG. 1 is a block diagram of an electronic device according to an example embodiment.

Referring to FIG. 1, an electronic device 100 according to an example embodiment may include a processor 110, a tuning circuit 120, and an antenna 130.

The electronic device 100 according to various embodiments may be various types of devices. Some examples of the electronic device 100 may include a mobile communication device (for example, a smartphone), a computer device, a portable multimedia device, a portable medical device, a camera, or a wearable device. However, the electronic device 100 according to an example embodiment is not limited to the above-mentioned devices.

According to an example embodiment, the electronic device 100 may include an antenna 130 transmitting and receiving radio-frequency (RF) signals. For example, the electronic device 100 may transmit and/or receive RF signals in a predetermined frequency band through the antenna 130.

Accordingly, the electronic device 100 may be referred to as an antenna device, a wireless communication device, or a wireless transceiver that includes an antenna 130.

In addition, the electronic device 100 may include a tuning circuit 120 connected to the antenna 130. For example, the electronic device 100 may include a tuning circuit 120 including a plurality of elements. Herein, an “element” of the tuning circuit 120 may be an active circuit component, e.g., a switch, controllable by a voltage or current corresponding to at least one bit of a tune code. Each switch may control a circuit path that connects/disconnects an impedance, e.g., a capacitance or an inductance, to a certain part of the tuning circuit and thereby adjusts the overall impedance of the tuning circuit 120.

The tuning circuit 120 according to an example embodiment may dynamically adjust internal impedance under the control of the processor 110 to significantly reduce a signal reflected from the antenna 130.

For example, the tuning circuit 120 may include an impedance tuner (or an impedance matching circuit) and/or an aperture tuner. The aperture tuner may be formed as a component of the antenna 130.

In addition, the electronic device 100 may include a processor 110 electrically connected to the tuning circuit 120, and a radio frequency (RF) front end 150 which is RF coupled between the processor 110 and the tuning circuit 120. For transmit operations, the processor 110 may output a digital transmit signal S_{TX} which may be digital to analog (D/A) converted, modulated, up-converted, filtered and amplified by the RF front end and output as an RF transmit signal RF_OUT to the tuning circuit 120. For receive operations, a receive path signal RF_R received by the antenna 120 and routed through the tuning circuit 120 may be amplified, filtered, demodulated, down-converted and A/D converted by the RF front end 150 and output as a digital receive signal S_{RX} to the processor 110.

The processor 110 may execute, for example, software (or a program) to control at least one other component of the electronic device 100 (for example, the tuning circuit 120) and perform various data processing or computations. The processor 110 may include a central processing unit or a microprocessor, and may control the overall operation of the electronic device 100. Therefore, it may be appreciated that the operations performed by the electronic device 100 are performed under the control of the processor 110.

According to one embodiment, the processor 110 may execute an algorithm to control the tuning circuit 120. For example, the algorithm may be software code programmed in memory, which is read and executed by the processor 110. For example, the algorithm may be hard code hardcoded in the processor 110, but example embodiments are not limited thereto.

The processor 110 may perform impedance tuning or impedance matching on the antenna 130 using the tuning circuit 120 based on the algorithm.

According to an example embodiment, the processor 110 may control the tuning circuit 120 using a tune code TC. For example, the processor 110 may control at least a portion of the plurality of elements, included in the tuning circuit 120, using the tune code TC.

For example, the tune code TC may include a plurality of bits, respectively corresponding to the plurality of elements included in the tuning circuit 120.

For example, the processor 110 may control at least a portion of the plurality of elements, included in the tuning circuit 120, based on to the plurality of bits included in the tune code TC.

As a result, the processor 110 may control impedance of an electrical path connected to the antenna 130.

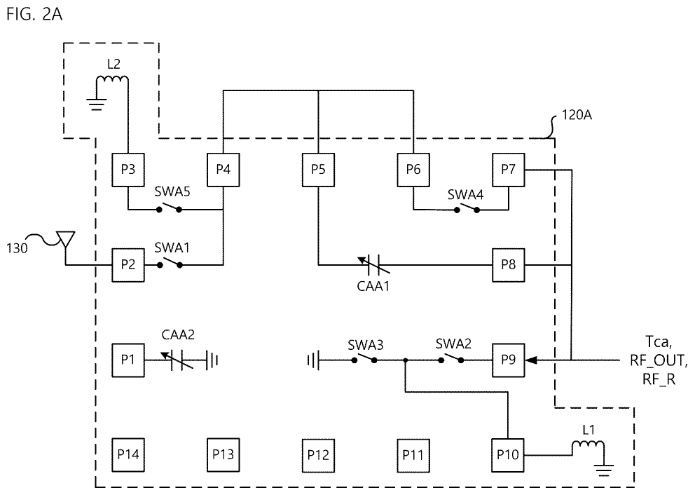

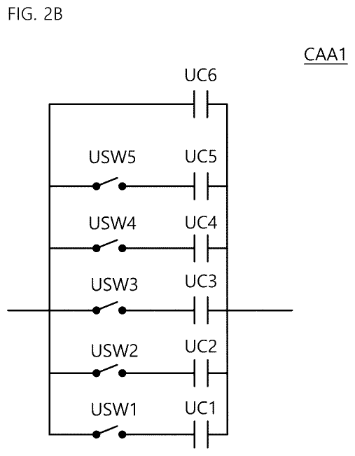

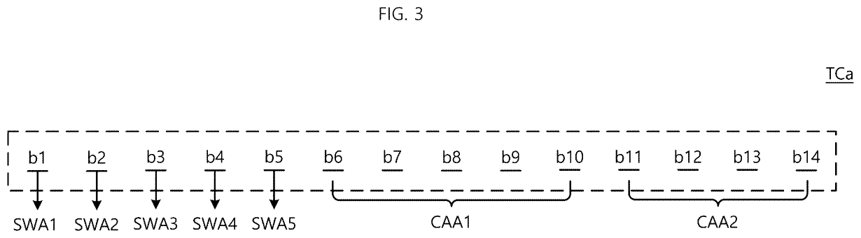

FIG. 2A is a circuit diagram of a tuning circuit according to an example embodiment. FIG. 2B is a circuit diagram illustrating a first capacitor array in the tuning circuit in FIG. 2A. FIG. 3 is a diagram illustrating a tune code including bits corresponding to a plurality of elements included in a tuning circuit according to an example embodiment.

Referring to FIG. 2A, a tuning circuit 120A according to an example embodiment may include a plurality of elements.

For example, the tuning circuit 120A may include a first switch SWA1 to a fifth switch SWA5, a first capacitor array CAA1, and a second capacitor array CAA2.

The tuning circuit 120A and tune code TCa illustrated in FIG. 2A may be understood as examples of the tuning circuit 120 and the tune code TC illustrated in FIG. 1, respectively. Therefore, the same or substantially the same components are represented by the same reference numerals, and redundant descriptions will be omitted to avoid repetition.

According to an example embodiment, the tuning circuit 120A may include a plurality of pads P1 to P14 connected to an external configuration of the tuning circuit 120A.

The general layout of the tuning circuit 120 may be a “universal” layout that allows for relatively easy wiring changes during a late manufacturing stage to add or delete reactive components (e.g., capacitances or inductances) at strategic locations of the tuning circuit 120. Meanwhile, a plurality of tune codes may be stored in memory that may be collectively applicable to all the possible wiring configurations of the tuning circuit 120. Tune codes that control switches that are each relevant to a current wiring configuration of the tuning circuit 120 (where each controllable switch may affect the overall impedance of the tuning circuit 120) may be referred to as valid tune codes.

However, when the tuning circuit 120 has a specific wiring, one or more of the reactive components may be fully disconnected (i.e., there is no switching mechanism allowing for dynamic reconnection) from the input to output circuit path, and therefore become irrelevant. The fully disconnected reactive component may not affect the impedance of any relevant electrical path between the RF input port of the tuning circuit to the antenna 130 (the “RF circuit path”), and may therefore be referred to as an invalid element. Further, a tune code with a control bit that turns on a switch that could otherwise add the fully disconnected reactive component to the circuit, if the switch exists and is physically wired to the RF circuit path, may be referred to as an invalid tune code.

The tuning circuit 120A may include, for example, a second pad P2 connected to an antenna 130. The tuning circuit 120A is shown schematically in FIG. 2A to include a ninth pad P9 receiving tune code TCa from the processor 110. However, the tuning circuit 120A may include suitable wiring and conversion circuitry (e.g., a serial to parallel converter) such that each active element among the switches SWA1 to SWA5 and the switches in the capacitor arrays CAA1 and CAA2 receives a respective signal representing one or more of the bits of the tune code TCa.

An RF transmit signal S_{TX} and/or an RF receive signal S_{RX} may be applied to/received from a selected one or more of the pads P1-P14 that are connectable to the antenna 130. In the example of FIG. 2A, the transmit signal S_{TX} is shown applied to each of the pads P7-P9, and the receive signal SRX may be a combined signal received from the pads P7-P9.

Also, the tuning circuit 120A may include, for example, a tenth pad P10 connected to a first inductor L1. Also, the tuning circuit 120A may include a third pad P3 connected to a second inductor L2.

The plurality of pads P1 to P14 according to an example embodiment may be connected to different pads, respectively. For example, the fourth pad P4, the fifth pad P5, and the sixth pad P6 may be electrically connected to each other.

The tuning circuit 120A may include a plurality of switches SWA1 to SWA5.

For example, the tuning circuit 120A may include a first switch SWA1 connected to the second pad P2, a second switch SWA2 connected to the ninth pad P9, a third switch SWA3 connected between a second switch SWA2 and ground, a fourth switch SWA4 connected between the sixth pad P6 and the seventh pad P7, and a fifth switch SWA5 connected between the third pad P3 and the fourth pad P4.

The tuning circuit 120A may include a first capacitor array CAA1 and a second capacitor array CAA2.

For example, the tuning circuit 120A may include a first capacitor array CAA1 connected in parallel to the fourth switch SWA4 in an electrical path connected from the processor 110 (through the RF front end 150) to the antenna 130.

Referring to FIG. 2B, the first capacitor array CAA1 according to an example embodiment may include a plurality of unit capacitors UC1 to UC6 connected in parallel to each other.

For example, the capacitance of the first unit capacitor UC1 may be twice the capacitance of the sixth unit capacitor UC6. For example, the capacitance of the second unit capacitor UC2 may be twice the capacitance of the first unit capacitor UC1. However, the capacitance of each unit capacitor is not limited to the above-mentioned examples.

The first capacitor array CAA1 may include a plurality of unit switches USW1 to USW5 connected in series with each of five unit capacitors UC1 to UC5, respectively, among the plurality of unit capacitors UC1 to UC6.

For example, the first capacitor array CAA1 may include the first unit capacitor UC1 and a first unit switch USW 1 connected in series with the first unit capacitor UC1.

For example, the first capacitor array CAA1 may include a second unit capacitor UC2 and a second unit switch USW2 connected in parallel to the first unit capacitor UC1 and the first unit switch USW1.

In addition, the tuning circuit 120A may include a second capacitor array CAA2 connected between the second pad P2 and ground.

According to an example embodiment, the second capacitor array CAA2 may have substantially the same configuration as the first capacitor array CAA1, except for the fifth unit capacitor UC5 and the fifth unit switch USW5 of the first capacitor array CAA1.

For example, the second capacitor array CAA2 may include five unit capacitors, connected in parallel to each other, and four unit switches connected in series with four unit capacitors, respectively, among the five unit capacitors.

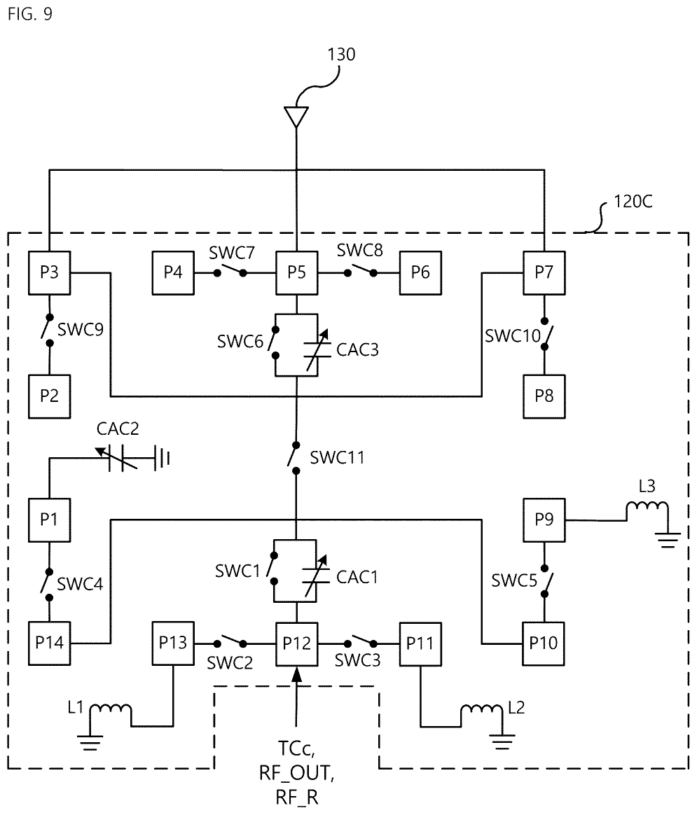

According to an example embodiment as shown in FIG. 2A, the second capacitor array CAA2 may be electrically separated from the electrical path connected from the processor 110 (through the RF front end 150) to the antenna 130. Therefore, the second capacitor array CAA2 does not affect the impedance of any relevant electrical path between the RF input port of the tuning circuit to the antenna 130 (the “input to output circuit path”), and may therefore be referred to as an invalid element. In other embodiments, such as in FIG. 9 described later, the second capacitor array (labeled CAC2 in FIG. 9) is connected to a relevant circuit path and may be a valid element in such an embodiment, since its impedance affects the overall impedance of the tuning circuit.

However, the circuit configurations of the first capacitor array CAA1 and the second capacitor array CAA2 are not limited to the above-described examples, and each capacitor array may have various circuit configurations based on combinations of at least two or more capacitors and switches.

Referring to FIG. 3, a tune code TCa according to an example embodiment may include a plurality of bits b1 to b14, respectively corresponding to the plurality of elements included in the tuning circuit 120A.

According to an example embodiment, the tune code TCa may include a first bit b1 to a fifth bit b5, respectively corresponding to the first switch SWA1 to the fifth switch SWA 5.

For example, the tune code TCa may include the first bit b1 corresponding to the first switch SWA1. Also, the tune code TCa may include the third bit b3 corresponding to the third switch SWA 3.

In addition, the tune code TCa according to an example embodiment may include a sixth bit b6 to a tenth bit b10 corresponding to the first capacitor array CAA1.

The sixth bit b6 to the tenth bit b10 corresponding to the first capacitor array CAA1 may be referred to as first capacitor bits. It may be appreciated that the sixth bit b6 to the tenth bit b10 constitute a 5-bit first capacitor code corresponding to the first capacitor array CAA1.

The tune code TCa according to an example embodiment may include an eleventh bit b11 to a fourteenth bit b14 corresponding to the second capacitor array CAA2.

For example, the tune code TCa may include an eleventh bit b11 to a fourteenth bit b14, respectively corresponding to the plurality of unit switches included in the second capacitor array CAA2.

The eleventh bit b11 to the fourteenth bit b14 corresponding to the second capacitor array CAA2 may be referred to as second capacitor bits. It may be appreciated that the eleventh bit b11 to the fourteenth bit b14 constitute 4-bit second capacitor code corresponding to the second capacitor array CAA2.

According to an example embodiment, the processor 110 may control the tuning circuit 120A using the tune code TCa including the plurality of bits b1 to b14.

For example, the processor 110 may control the plurality of elements included in the tuning circuit 120A using the tune code TCa including the plurality of bits b1 to b14.

For example, the processor 110 may turn on the first switch SWA 1 of the tuning circuit 120A using the tune code TCa in which a value of the first bit b1 is “1.”

For example, the processor 110 may control the capacitance of the first capacitor array CAA1 by setting each of the sixth bit b6 to the tenth bit b10 to “0” or “1.”

For example, the processor 110 may control the capacitance of the second capacitor array CAA2 by setting each of the eleventh bit b11 to the fourteenth bit b14 to “0” or “1.”

As a result, the processor 110 may control the impedance of the tuning circuit 120A.

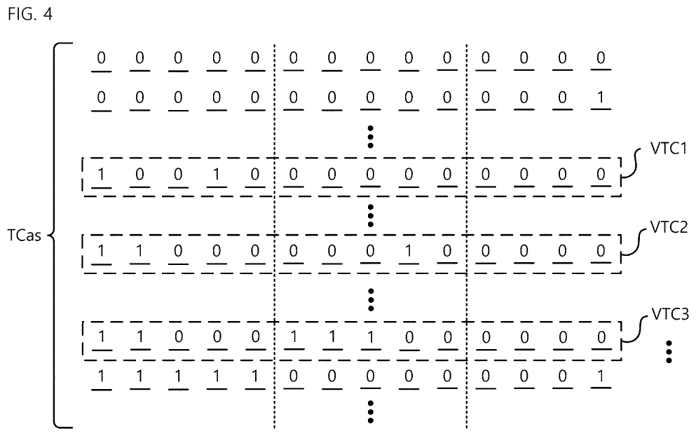

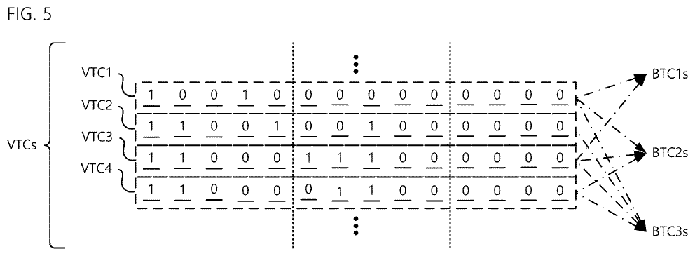

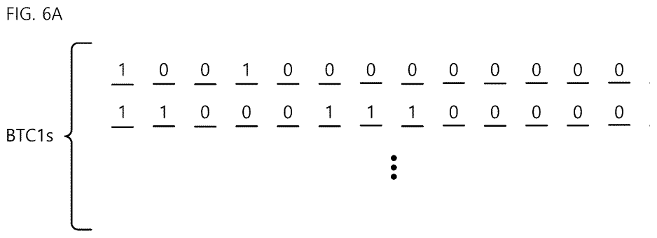

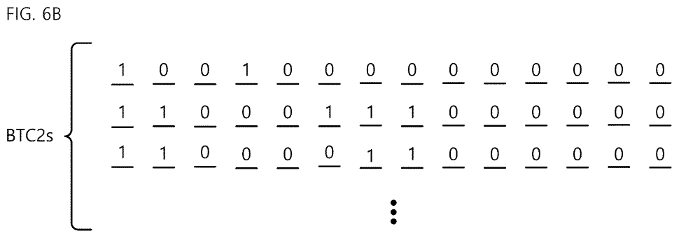

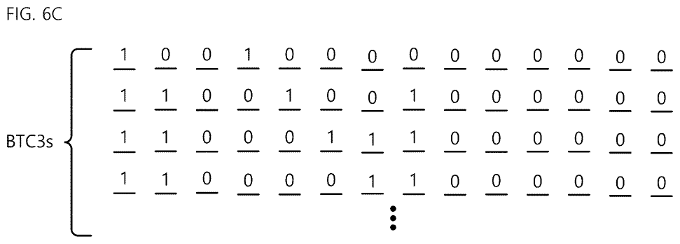

FIG. 4 is a diagram illustrating a plurality of tune codes generated from information related to a plurality of elements according to an example embodiment. FIG. 5 is a diagram illustrating a plurality of valid tune codes satisfying basic rules, among a plurality of tune codes according to an example embodiment. FIG. 6A is a diagram illustrating a plurality of “first band” tune codes satisfying a “first band rule”, among a plurality of valid tune codes according to an example embodiment. Herein, first band tune codes control elements of a tuning circuit operating in a first frequency band; a first band rule is a rule applicable to the operation in the first frequency band; “second band tune codes” control elements of the tuning circuit operating in a second, different frequency band; and so forth. FIG. 6B is a diagram illustrating a plurality of second band tune codes satisfying a second band rule, among a plurality of valid tune codes according to an example embodiment. FIG. 6C is a diagram illustrating a plurality of third band tune codes satisfying a third band rule, among a plurality of valid tune codes according to an example embodiment.

Referring to FIG. 4, a processor 110 according to an example embodiment may generate a plurality of tune codes TCas based on information on a plurality of elements included in a tuning circuit 120A.

The processor 110 may generate a plurality of tune codes TCas having different values based on information on the plurality of elements included in the tuning circuit 120A.

The information on the plurality of elements included in the tuning circuit 120A may include first information including an arrangement and a connection relationship of the plurality of elements.

Also, the information on the plurality of elements included in the tuning circuit 120A may include second information on an element, respectively corresponding to the plurality of bits b1 to b14 among the plurality of elements.

Therefore, the electronic device 100 according to an example embodiment may further include an interface for receiving the information on the plurality of elements. Also, the electronic device 100 may further include a memory (or a memory device) storing the input information on the plurality of elements.

Each of the plurality of bits b1 to b14 may have a value of “0” or “1” represented in binary. Accordingly, for example, when the tune code TCa includes 14 bits, the processor 110 may generate 2¹⁴-1 tune codes TCas.

Referring to FIGS. 4 and 5, the processor 110 according to an example embodiment may identify a plurality of valid tune codes VTCs satisfying a default rule, among the plurality of tune codes TCas.

For example, the processor 110 may identify a plurality of valid tune codes VTCs, satisfying a default rule set for at least a portion of the plurality of bits b1 to b14, from the plurality of tune codes TCas.

According to an example embodiment, information (or data) on the default rule may be stored in a memory (or a memory device) provided in the electronic device 100.

The default rule according to an example embodiment may include a first default rule in which the first bit b1 has a predetermined first value (for example, “1”).

For example, the default rule may include a first default rule in which the first bit b1 corresponding to a first switch SWA1 has a predetermined first value (for example, “1”).

In the connection configuration of FIG. 2A, the first switch SWA1 may be understood as a switch connected closest to an antenna 130 within the tuning circuit 120A. For example, when the first switch SWA1 is turned off, the electrical path connected from the processor 110 to the antenna 130 (through the RF front end 150) may be disconnected, which is the case for all possible tune codes that include “0” for the first bit.

Accordingly, the processor 110 may identify a tune code satisfying a first default rule in which the first bit b1 corresponding to the first switch SWA1 has a predetermined first value (for example, “1”) such that the first switch SWA1 connected to the antenna 130 is maintained in an ON state.

The default rule may include a second default rule, in which the third bit b3 has a predetermined value, when the second bit b2 has a second value.

For example, the default rule may include a second default rule, in which the third bit b3 corresponding to a third switch SWA3 has a predetermined value (for example, “0”) when the second bit b2 corresponding to a second switch SWA2 has a second value (for example, “0”).

The second switch SWA2 and the third switch SWA3 may be connected in series between the processor 110 and the ground. For example, when the second switch SWA2 is in an OFF state, the operation of the third switch SWA3 may not affect the electrical path connected from the processor 110 (through the RF front end 150) to the antenna 130.

Accordingly, the processor 110 may identify a tune code satisfying a second default rule, in which the third bit b3 corresponding to the third switch SWA3 has a predetermined value (for example, “0”) when the second switch SWA2 is in an OFF state.

The default rule may include a third default rule, in which the sixth bit b6 to the tenth bit b10 have predetermined values, when the fourth bit b4 has a first value.

For example, the default rule may include a third default rule in which the sixth bit b6 to the tenth bit b10 corresponding to the first capacitor array CAA1 have a predetermined value (for example, “0”) when the fourth bit b4 corresponding to a fourth switch SWA4 has a first value (for example, “1”).

The fourth switch SWA4 and the first capacitor array CAA1 may be connected in parallel. For example, when the fourth switch SWA4 is in an ON state, the capacitance of the first capacitor array CAA1 may not affect the electrical path connected from the processor 110 to the antenna 130 (through the RF front end 150).

Accordingly, the processor 110 may identify a tune code satisfying a third default, rule in which each of the sixth bit b6 to the tenth bit b10 corresponding to the first capacitor array CAA1 has a predetermined value (for example, “0”) when the fourth switch SWA4 is in ON state.

In addition, the default rule may include a fourth default rule in which the eleventh bit b11 to the fourteenth bit b14 have predetermined values.

For example, the default rule may include a fourth default rule in which the eleventh bit b11 to the fourteenth bit b14 corresponding to the second capacitor array CAA2 have a predetermined value (for example, “0”).

According to an example embodiment, the second capacitor array CAA2 may be understood as an invalid element, electrically separated from the electrical path connected from the processor 110 (through the RF front end 150) to the antenna 130. Also, the eleventh bit b11 to the fourteenth bit b14 corresponding to the second capacitor array CAA2 may be referred to as invalid bits.

For example, the magnitude of the capacitance of the second capacitor array CAA2 may not electrically affect the electrical path connected from the processor 110 (through the RF front end 150) to the antenna 130.

Therefore, the processor 110 may identify a tune code satisfying a fourth default rule in which each of the eleventh bit b11 to the fourteenth bit b14 corresponding to the second capacitor array CAA2 has a predetermined value (for example, “0”).

As a result, the processor 110 (or the electronic device 100) may reduce the time and costs required for impedance matching due to tune codes in which invalid bits corresponding to invalid elements having no effect on the impedance of the antenna 130 have different values.

In addition, the default rule may include a fifth default rule in which at least a portion of the second bit b2 and the third bit b3 have a first value (for example, “0”).

For example, the default rule may include a fifth default rule in which at least one of the second bit b2 corresponding to the second switch SWA2 and the third bit b3 corresponding to the third switch SWA3 have a first value (for example, “0”). The second switch SWA 2 and the third switch SWA3 may be connected in series between the processor 110 and ground. For example, when both the second switch SWA2 and the third switch SWA3 are turned on, the processor 110 may be connected to the ground (through the inductor L1).

For example, the processor 110 may identify a tune code satisfying a fifth default rule causing at least one of the second switch SWA2 and the third switch SWA3 to be turned off.

According to an example embodiment, the processor 110 may identify a plurality of valid tune codes VT Cs satisfying all of the first default rule to the fifth default rule, among the plurality of tune codes TCas.

For example, the processor 110 may identify a first valid tune code VTC1 “10010000000000” satisfying all of the first default rule to the fifth default rule, among the plurality of tune codes TCas.

For example, the processor 110 may identify a second valid tune code VTC2 “11000000100000” satisfying all of the first default rule to the fifth default rule, among the plurality of tune codes TCas.

Referring to the above-described configurations, the processor 110 may identify a plurality of valid tune codes VTCs, among a plurality of tune codes TC as for controlling the tuning circuit 120A, based on information related to the tuning circuit 120A and a prestored default rule.

For example, the processor 110 may identify a plurality of valid tune codes VTCs other than tune codes interrupting a valid electrical path or having redundant circuitry (that does not affect the overall impedance of the tuning circuit, whether or not the circuitry is included).

As a result, the electronic device 100 according to an example embodiment may significantly reduce the time and costs required for impedance matching due to tune codes interrupting a valid electrical path or having redundant circuitry.

Furthermore, referring to FIGS. 5, 6A to 6C, the processor 110 may identify a band tune code that is valid for each of the first frequency band to the third frequency band, among the plurality of valid tune codes VTCs.

For example, the first frequency band may be referred to as a frequency band of less than about 1 GHz. For example, the second frequency band may be referred to as a frequency band of about 1 GHz or more to less than about 2 GHz. For example, the third frequency band may be referred to as a frequency band of about 2.3 GHz or more to less than 3 GHz. However, each frequency band is not limited to the above-mentioned examples.

For example, the processor 110 may identify band tune codes satisfying band rules set for each frequency band, among the plurality of valid tune codes VTCs.

Referring to FIG. 6A, the processor 110 may identify first band tune codes BTC1s that are valid for the first frequency band, among the plurality of valid tune codes VTCs.

According to an example embodiment, the processor 110 may identify first band tune codes BTC1s satisfying a first band rule set for the first frequency band, among the plurality of valid tune codes VTCs.

The processor 110 may identify first band tune codes BTC1s satisfying a first band rule set for the bits corresponding to the first capacitor array CAA1, among the plurality of valid tune codes VTCs.

The first band rule may include, that a first capacitor code, including bits corresponding to the first capacitor array CAA 1, has a value greater than or equal to a first lower limit code.

For example, the first band rule may include, that the first capacitor code has a value greater than or equal to a first lower limit code corresponding to a first lower limit value set for the first frequency band such that the first capacitor array CAA1 has a capacitance greater than or equal to the first lower limit value set for the first frequency band.

For example, the first band rule may include, that a first capacitor, including the sixth bit b6 to the tenth bit b10, has a value greater than or equal to “10000.” For example, the processor 110 may determine that a tune code having a first capacitor code of “10101,” among the plurality of valid tune codes VTCs, satisfies the first band rule.

According to an example embodiment, the first band rule may further include an inductor rule in which at least one bit, among bits corresponding to switches connected to an inductor (for example, the second switch SWA2) and bits corresponding to the fifth switch SWA5, has a first value (for example, “0”).

For example, the first band rule may further include an inductor rule in which at least one of the second bit b2 and fifth bit b5, corresponding to switches connected to an inductor, is “0.”

For example, the processor 110 may identify first band tune codes BTC1s in which at least one of the second bit b2 and the fifth bit b5 is “0” and the first capacitor code has a value greater than or equal to “10000,” among the plurality of valid tune codes VTCs.

For example, the processor 110 may identify a tune code “10010000000000” satisfying the first band rule as one of the first band tune codes BTC1s, among the plurality of valid tune codes VTCs.

Referring to FIG. 6B, the processor 110 may identify second band tune codes BTC2s that are valid for the second frequency band, among the plurality of valid tune codes VTCs.

The processor 110 according to an example embodiment may identify second band tune codes BTC2s satisfying a second band rule set for the second frequency band, among the plurality of valid tune codes VTCs.

The processor 110 may identify second band tune codes BTC2s satisfying a second band rule set for the bits corresponding to the first capacitor array CAA1, among the plurality of valid tune codes VTCs.

The second band rule may include, that code, including bits corresponding to the first capacitor array CAA1 (hereinafter referred to as “first capacitor code”), has a value greater than or equal to a second lower limit code smaller than the first lower limit code.

For example, the second band rule may include, that the first capacitor code has a value greater than or equal to a second lower limit code corresponding to a second lower limit value set for the first frequency band such that the first capacitor array CAA1 has a capacitance greater than or equal to the second lower limit value smaller than the first lower limit value.

For example, the second band rule may include, that the first capacitor, including the sixth bit b6 to the tenth bit b10, has a value greater than or equal to “01000.” For example, the processor 110 may determine that a tune code having a first capacitor code of “01100,” among the plurality of valid tune codes VTCs, satisfies the second band rule.

Accordingly, the processor 110 may identify tune codes having a first capacitor code value greater than or equal to “01000,” among the plurality of valid tune codes VTCs.

For example, the processor 110 may identify a tune code “11000111000000” satisfying the second band rule as one of the second band tune codes BTC2s, among the plurality of valid tune codes VTCs.

Referring to FIG. 6C, the processor 110 may identify third band tune codes BTC3s that are valid for the third frequency band, among the plurality of valid tune codes VTCs.

According to an example embodiment, the processor 110 may identify third band tune codes BTC3s satisfying a third band rule set for the third frequency band, among the plurality of valid tune codes VTCs.

The processor 110 may identify third band tune codes BTC3s satisfying a third band rule set for the bits corresponding to the first capacitor array CAA1, among the plurality of valid tune codes VTCs.

The third band rule may include, wherein the first capacitor code has a value greater than or equal to a third lower limit code smaller than the second lower limit code.

For example, the third band rule may include, that the first capacitor code has a value greater than or equal to a third lower limit code corresponding to a third lower limit value set for the third frequency band such that the first capacitor array CAA1 has a capacitance greater than or equal to the third lower limit value.

For example, the third band rule may include, that the first capacitor code, including the sixth bit b6 to the tenth bit b10, has a value greater than or equal to “00100.”

Accordingly, the processor 110 may identify third band tune codes BTC3s having a first capacitor code value greater than or equal to “00100,” among the plurality of valid tune codes VTCs. For example, the processor 110 may determine that a tune code having a first capacitor code of “00111” satisfies the third band rule.

For example, the processor 110 may identify a tune code “11001001000000” satisfying the third band rule as one of the third band tune codes BTC3s, among the plurality of valid tune codes VTCs.

According to an example embodiment, the electronic device 100 may further include a memory (or a memory device) storing the first band rule, the second band rule, and the third band rule. Furthermore, the memory (or the memory device) may store the first band tune codes BTC1s, the second band tune codes BTC2s, and the third band tune codes BTC3s.

Furthermore, the processor 110 may control the tuning circuit 120A using one of the band tune codes identified for each frequency band, when the electronic device 100 transmits or receives an RF signal of a predetermined frequency band through the antenna 130.

According to an example embodiment, the processor 110 may select one of the first band tune codes BTC1s when the electronic device 100 transmits or receives an RF signal of a first frequency band through the antenna 130.

For example, the processor 110 may select one of the first band tune codes BTC1s based on a reflection coefficient measured from the antenna 130 when the electronic device 100 transmits or receives the RF signal of the first frequency band through the antenna 130.

According to an example embodiment, the processor 110 may select one of the second band tune codes BTC2s when the electronic device 100 transmits or receives an RF signal of the second frequency band through the antenna 130.

For example, the processor 110 may select one of the second band tune codes BTC2s based on the reflection coefficient measured from the antenna 130 when the electronic device 100 transmits or receives the RF signal of the second frequency band through the antenna 130.

According to an example embodiment, the processor 110 may select one of the third band tune codes BTC3s when the electronic device 100 transmits or receives an RF signal of a third frequency band through the antenna 130.

For example, the processor 110 may select one of the third band tune codes BTC3s based on the reflection coefficient measured from the antenna 130 when the electronic device 100 transmits or receives the RF signal of the third frequency band through the antenna 130.

Furthermore, the processor 110 may control the tuning circuit 120A using the selected tune code.

Referring to the above-described configurations, the processor 110 may identify a plurality of band tune codes BTC1s, BTC2s, and BTC3s that are valid for each frequency band, among the plurality of valid tune codes VTCs, based on a prestored band rule corresponding to each frequency band.

Furthermore, the processor 110 may control the tuning circuit 120A using one of the plurality of band tune codes BTC1s, BTC2s, and BTC3s, identified for each frequency band, based on the frequency band of the RF signal transmitted or received through the antenna 130.

As a result, the electronic device 100 according to an example embodiment may reduce the time and costs required to select a valid tune code depending on the frequency band.

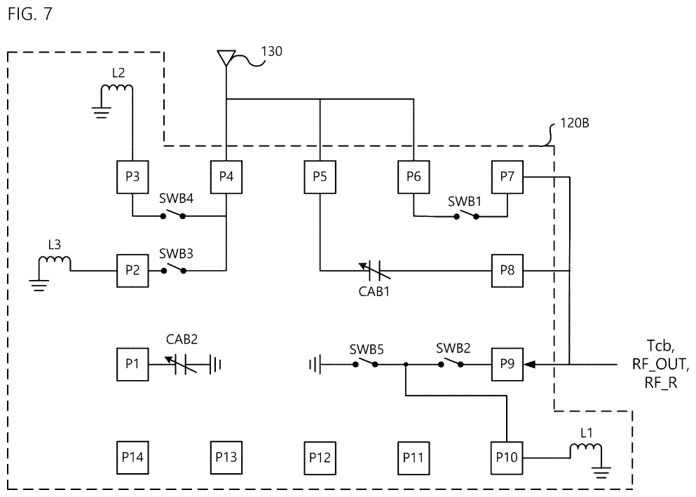

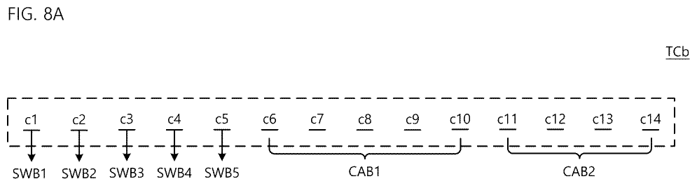

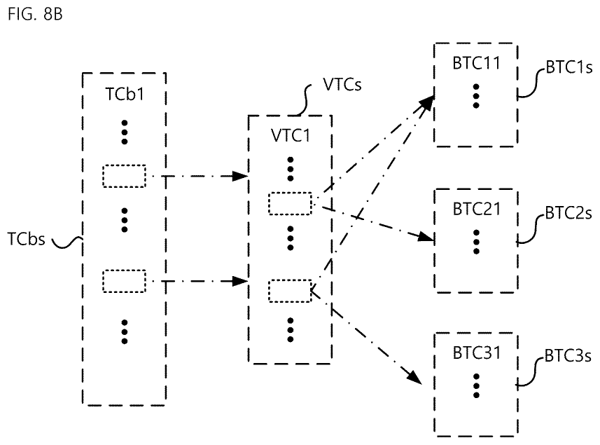

FIG. 7 is a circuit diagram of a tuning circuit according to an example embodiment. FIG. 8A is a diagram illustrating a tune code including bits corresponding to a plurality of elements included in a tuning circuit according to an example embodiment. FIG. 8B is a diagram illustrating a configuration to identify band tune codes of each frequency band from a plurality of valid tune codes according to an example embodiment.

Referring to FIG. 7, a tuning circuit 120B according to an example embodiment may include a plurality of elements.

For example, the tuning circuit 120B may include a first switch SWB1 to a fifth switch SWB5, a first capacitor array CAB1, and a second capacitor array CAB2.

The tuning circuit 120B illustrated in FIG. 7 and the tune code TCb may be understood as examples of the tuning circuit 120 and the tune code TC illustrated in FIG. 1, respectively. Therefore, the same or substantially the same components are represented by the same reference numerals, and redundant descriptions will be omitted to avoid repetition.

According to an example embodiment, the tuning circuit 120B may include a plurality of pads P1 to P14 connected to an RF front end external to the tuning circuit 120B.

For example, the tuning circuit 120B may include a fourth pad P4, a fifth pad P5, and a sixth pad P6 connected to the antenna 130. The tuning circuit 120B may further include a ninth pad P9 receiving the tune code TCb from the processor 110.

The tuning circuit 120B may include a tenth pad P10 connected to a first inductor L1. Also, the tuning circuit 120B may include a third pad P3 connected to a second inductor L2, and a second pad P2 connected to a third inductor L3.

Each of the plurality of pads P1 to P14 according to an example embodiment may be connected to another pad. For example, the fourth pad P4, the fifth pad P5, and the sixth pad P6 may be electrically connected to each other.

Also, the tuning circuit 120B may include a plurality of switches SWB1 to SWB5.

The tuning circuit 120B may include a first switch SWB1 connected between the sixth pad P6 and the seventh pad P7. The tuning circuit 120B may further include a second switch SWB2 connected to the ninth pad P9; a third switch SWB3 connected between the fourth pad P4 and the second pad P2; a fourth switch SWB4 connected between the fourth pad P4 and the third pad P3; and a fifth switch SWB5 connected between the second switch SWB2 and ground.

Also, the tuning circuit 120B may include a first capacitor array CAB1 and a second capacitor array CAB2.

For example, the tuning circuit 120B may include a first capacitor array CAB1 connected between the eighth pad P8 and the fifth pad P5.

The first capacitor array CAB1 according to an example embodiment may have substantially the same configuration as the first capacitor array CAA1 illustrated in FIG. 2B.

The first capacitor array CAB1 may be connected in parallel to the first switch SWB1 in an electrical path connected from the processor 110 (through the RF front end 150) to the antenna 130.

The tuning circuit 120B may include a second capacitor array CAB2 connected between the first pad P1 and ground.

According to an example embodiment, the second capacitor array CAB2 may include five unit capacitors, connected in parallel, and four unit switches connected in series with four of the five unit capacitors, respectively.

According to an example embodiment, the second capacitor array CAB2 may be electrically separated from the electrical path connected from the processor 110 (through the RF front end 150) to the antenna 130. Accordingly, the second capacitor array CAB2 may be referred to as an invalid element.

Referring to FIG. 8A, the tune code TCb according to an example embodiment may include a plurality of bits c1 to c14, respectively corresponding to the plurality of elements included in the tuning circuit 120B.

According to an example embodiment, the tune code TCb may include a first bit c1 to a fifth bit c5, respectively corresponding to the first switch SWB1 to the fifth switch SWB5.

The tune code TCb may include a first bit c1 corresponding to the first switch SWB1; and a third bit c3 corresponding to the third switch SWB3.

The tune code TCb may further include a sixth bit c6 to a tenth bit c10 corresponding to the first capacitor array CAB1.

The sixth bit c6 to the tenth bit c10 corresponding to the first capacitor array CAB1 may be referred to as first capacitor bits. Also, the sixth bit c6 to the tenth bit c10 may be understood as constituting a 5-bit first capacitor code corresponding to the first capacitor array CAB1.

The tune code TCb according to an example embodiment may include an eleventh bit c11 to a fourteenth bit c14 corresponding to the second capacitor array CAB2.

For example, the tune code TCb may include an eleventh bit c11 to a fourteenth bit c14, respectively corresponding to the plurality of unit switches included in the second capacitor array CAB2.

The eleventh bit c11 to the fourteenth bit c14 corresponding to the second capacitor array CAB2 may be referred to as second capacitor bits. Also, the eleventh bit c11 to the fourteenth bit c14 may be understood as constituting a 4-bit second capacitor code corresponding to the second capacitor array CAB2.

According to an example embodiment, the processor 110 may control the tuning circuit 120B using the tune code TCb including the plurality of bits c1 to c14.

For example, the processor 110 may control a plurality of elements included in the tuning circuit 120B using the tune code TCb including the plurality of bits c1 to c14. An RF transmit signal S_{TX} and/or an RF receive signal S_{RX} may be applied to/received from a selected one or more of the pads P1-P14 that are connectable to the antenna 130. In the example of FIG. 7, the transmit signal STX is shown applied to each of the pads P7-P9, and the receive signal SRX may be a combined signal received from the pads P7-P9.

For example, the processor 110 may turn on the first switch SWB1 of the tuning circuit 120B using the tune code TCb in which a value of the first bit c1 is “1.”

For example, the processor 110 may control the capacitance of the first capacitor array CAB1 by setting each of the values of the sixth bit c6 to the tenth bit c10 to “0” or “1.”

For example, the processor 110 may control the capacitance of the second capacitor array CAB2 by setting each of the values of the eleventh bit c11 to the fourteenth bit c14 to “0” or “1.”

As a result, the processor 110 may control the impedance of the tuning circuit 120B.

Referring to FIG. 8B, the processor 110 according to an example embodiment may generate a plurality of tune codes TCbs based on information on a plurality of elements included in the tuning circuit 120B.

For example, the processor 110 may generate a plurality of tune codes TCbs having different values based on the information on the plurality of elements included in the tuning circuit 120B.

For example, the information on the plurality of elements included in the tuning circuit 120B may include first information including an arrangement and a connection relationship of the plurality of elements.

Also, the information on the plurality of elements included in the tuning circuit 120B may include second information on an element, respectively corresponding to a plurality of bits c1 to c14, among the plurality of elements.

Accordingly, the electronic device 100 may further include an interface for receiving the information on the plurality of elements. Also, the electronic device 100 may further include a memory (or a memory device) storing the input information on the plurality of elements.

Each of the plurality of bits c1 to c14 may have a value of “0” or “1” represented in binary. Accordingly, for example, when the tune code TCb includes 14 bits, the processor 110 may generate 2¹⁴-1 tune codes TCbs.

Also, the processor 110 according to an example embodiment may identify a plurality of valid tune codes VT Cs satisfying the default rule, among the plurality of tune codes TCbs.

For example, the processor 110 may identify a plurality of valid tune codes VTCs satisfying a default rule set for at least a portion of the plurality of bits c1 to c14, among the plurality of tune codes TCbs.

According to an example embodiment, information (or data) on the default rule may be stored in a memory (or a memory device) provided in the electronic device 100.

The default rule may include a first default rule in which the fifth bit c5 has a predetermined value when the second bit c2 has a second value.

For example, the default rule may include a first default rule in which the fifth bit c5 has a predetermined value (for example, “0”) when the second bit c2 corresponding to the second switch SWB2 has a second value (for example, “0”).

The second switch SWB2 and the fifth switch SWB5 may be connected in series between the processor 110 and the ground. For example, when the second switch SWB2 is in an OFF state, the operation of the fifth switch SWB5 may not affect the electrical path connected from the processor 110 to the antenna 130 (through the RF front end 150).

Accordingly, the processor 110 may identify a tune code satisfying a first default rule in which the fifth bit c5 corresponding to the fifth switch SWB5 has a predetermined value (for example, “0”) when the second switch SWB2 is turned off. Also, the default rule may include a second default rule in which the sixth bit c6 to the tenth bit c10 have a predetermined value when the first bit c1 has a first value.

For example, the default rule may include a second default rule in which the sixth bit c6 to the tenth bit c10 corresponding to the first capacitor array CAB1 have a predetermined value (for example, “0”) when the first bit c1 corresponding to the first switch SWB1 has a first value (for example, “1”).

The first switch SWB1 and the first capacitor array CAB1 may be connected in parallel in the electrical path connected from the processor 110 (through the RF front end 150) to the antenna 130. For example, when the first switch SWB1 is in an ON state, the capacitance of the first capacitor array CAB1 may not affect the electrical path connected from the processor 110 (through the RF front end 150) to the antenna 130.

Accordingly, the processor 110 may identify a tune code satisfying a second default rule in which each of the sixth bit c6 to the tenth bit c10 corresponding to the first capacitor array CAB1 has a predetermined value (for example, “0”) when the first switch SWB1 is turned on.

The default rule may include a third default rule in which the eleventh bit c11 to the fourteenth bit c14 have a predetermined value.

For example, the default rule may include a third default rule in which the eleventh bit c11 to the fourteenth bit c14 corresponding to the second capacitor array CAB2 have a predetermined value (for example, “0”).

According to an example embodiment, the second capacitor array CAB2 may be understood as an invalid element, electrically separated from the electrical path connected from the processor 110 to the antenna 130 (through the RF front end 150). Also, the eleventh bit c11 to the fourteenth bit c14 corresponding to the second capacitor array CAB2 may be referred to as invalid bits.

For example, the magnitude of the capacitance of the second capacitor array CAB2 may not electrically affect the electrical path connected from the processor 110 (through the RF front end 150) to the antenna 130.

Accordingly, the processor 110 may identify a tune code satisfying a third default rule in which each of the eleventh bit c11 to the fourteenth bit c14 corresponding to the second capacitor array CAB2, which is an invalid element, has a predetermined value (for example, “0”).

As a result, the processor 110 (or the electronic device 100) may reduce the time and costs required for impedance matching due to tune codes in which invalid bits corresponding to an invalid element, which does not affect the impedance of the antenna 130, have different values.

Also, the default rule may include a fourth default rule in which at least a portion of the second bit c2 and the fifth bit c5 have a first value (for example, “0”).

For example, the default rule may include a fourth default rule in which at least a portion of the second bit c2 corresponding to the second switch SWB2 and the fifth bit c5 corresponding to the fifth switch SWB5 have a first value (for example, “0”).

The second switch SWB2 and the fifth switch SWB5 may be connected in series between the processor 110 and ground. For example, when both the second switch SWB2 and the fifth switch SWB5 are turned on, the processor 110 may be connected to the ground (through the inductor L1).

For example, the processor 110 may identify a tune code satisfying a fourth default rule causing at least one of the second switch SWB2 and the fifth switch SWB5 to be turned off.

According to an example embodiment, the processor 110 may identify a plurality of valid tune codes VTCs satisfying all of the first default rule to the fourth default rule, among the plurality of tune codes TCbs.

Referring to the above-described configurations, the processor 110 may identify a plurality of valid tune codes VTCs, among a plurality of tune codes TCbs for controlling the tuning circuit 120B, based on information related to the tuning circuit 120B and the prestored default rule.

For example, the processor 110 may identify a plurality of valid tune codes VTCs other than tune codes interrupting a valid electrical path or having redundant circuitry.

As a result, the electronic device 100 according to an example embodiment may significantly reduce time and costs required for impedance matching due to tune codes interrupting a valid electrical path or having redundant circuitry.

Also, the processor 110 may identify band tune codes valid for each of the first frequency band to the third frequency band, among the plurality of valid tune codes VTCs.

For example, the first frequency band may be referred to as a frequency band of less than about 1 GHz. For example, the second frequency band may be referred to as a frequency band of about 1 GHz or more to less than about 2 GHz. For example, the third frequency band may be referred to as a frequency band of about 2.3 GHz or more to less than 3 GHz. However, each frequency band is not limited to the above-mentioned examples.

For example, the processor 110 may identify band tune codes satisfying band rules set for each frequency band, among the plurality of valid tune codes VTCs.

According to an example embodiment, the processor 110 may identify first band tune codes BTC1s that are valid for the first frequency band, among the plurality of valid tune codes VTCs.

According to an example embodiment, the processor 110 may identify first band tune codes BTC1s satisfying a first band rule set for the first frequency, band among the plurality of valid tune codes VTCs.

The processor 110 may identify first band tune codes BTC1s satisfying a first band rule set for the bits corresponding to the first capacitor array CAB1, among the plurality of valid tune codes VTCs.

The first band rule may include, wherein the first capacitor code, including the bits corresponding to the first capacitor array CAB1, has a value greater than or equal to a first lower limit code.

For example, the first band rule may include, wherein the first capacitor code has a value greater than or equal to a first lower limit code corresponding to a first lower limit value set for the first frequency band such that the first capacitor array CAB1 has a capacitance greater than or equal to the first lower limit value.

For example, the first band rule may include, wherein the first capacitor code, including the sixth bit c6 to the tenth bit c10, has a value greater than or equal to “10000.” For example, the processor 110 may determine that a tune code having a first capacitor code of “10101” satisfies the first band rule.

According to an example embodiment, the first band rule may further include an inductor rule in which at least one of the bits corresponding to the switches (for example, the second switch SWB2, the third switch SWB3, and the fourth switch SWB4) connected to the inductor has a first value (for example, “0”).

For example, the first band rule may further include an inductor rule in which at least one of the second bit c2, the third bit c3, and the fourth bit c4 corresponding to switches connected to the inductor is “0.”

For example, the processor 110 may identify first band tune codes BTC1s, in which at least one of the second bit c2, the third bit c3, and the fourth bit c4 has a value of “0” and the first capacitor code has a value greater than or equal to “10000,” among the plurality of valid tune codes VTCs.

Also, the processor 110 according to an example embodiment may identify second band tune codes BTC2s that are valid for the second frequency band, among the plurality of valid tune codes VTCs.

The processor 110 according to an example embodiment may identify second band tune codes BTC2s satisfying a second band rule set for the second frequency band, among the plurality of valid tune codes VTCs.

The processor 110 may identify second band tune codes BTC2s satisfying a second band rule set for the bits corresponding to the first capacitor array CAB1, among the plurality of valid tune codes VTCs.

The second band rule may include, wherein the first capacitor code, including the bits corresponding to the first capacitor array CAB1, has a value greater than or equal to a second lower limit code smaller than the first lower limit code.

For example, the second band rule may include, wherein the first capacitor code has a value greater than or equal to a second lower limit code corresponding to a second lower limit value, smaller than the first lower limit value, such that the first capacitor array CAB1 has a capacitance greater than or equal to the second lower limit value but less than the first lower limit value.

For example, the second band rule may include, wherein the first capacitor code, including the sixth bit c6 to the tenth bit c10, has a value greater than or equal to “01000.” For example, the processor 110 may determine that a tune code having a first capacitor code of “01100” satisfies the second band rule.

Accordingly, the processor 110 may identify a tune code in which the first capacitor code has a value greater than or equal to “01000,” among the plurality of valid tune codes VTCs.

Also, the processor 110 according to an example embodiment may identify third band tune codes BTC3s that are valid for the third frequency band, among the plurality of valid tune codes VTCs.

According to an example embodiment, the processor 110 may identify third band tune codes BTC3s satisfying a third band rule set for the third frequency band, among the plurality of valid tune codes VTCs.

The processor 110 may identify third band tune codes BTC3s satisfying a third band rule set for the bits corresponding to the first capacitor array CAB1, among the plurality of valid tune codes VTCs.

The third band rule may include, wherein the first capacitor code has a value greater than or equal to a third lower limit code smaller than the second lower limit code.

For example, the third band rule may include, wherein the first capacitor code has a value greater than or equal to a third lower code corresponding to a third lower limit such that the first capacitor array CAB1 has a capacitance greater than or equal to the third lower limit set for the third frequency band.

For example, the third band rule may include, wherein the first capacitor code, including the sixth bit c6 to the tenth bit c10, has a value greater than or equal to “00100.”

Accordingly, the processor 110 may identify third band tune codes BTC3s in which the first capacitor code has a value greater than or equal to “00100,” among the plurality of valid tune codes VTCs. For example, the processor 110 may determine that a tune code having a first capacitor code of “00111”, among the plurality of valid tune codes VTCs, satisfies the third band rule.

According to an example embodiment, the electronic device 100 may further include a memory (or a memory device) storing the first band rule, the second band rule, and the third band rule. The memory (or the memory device) may store the first band tune codes BTC1s, the second band tune codes BTC2s, and the third band tune codes BTC3s.

Furthermore, the processor 110 may control the tuning circuit 120B using one of the band tune codes identified for each frequency band, when the electronic device 100 transmits and receives an RF signal of the predetermined frequency band through the antenna 130.

According to an example embodiment, the processor 110 may select one of the first band tune codes BTC1s when the electronic device 100 transmits and receives an RF signal of a first frequency band through the antenna 130.

For example, the processor 110 may select one of the first band tune codes BTC1s based on a reflection coefficient measured from the antenna 130, when the electronic device 100 transmits and receives the RF signal of the first frequency band through the antenna 130.

According to an example embodiment, the processor 110 may select one of the second band tune codes BTC2s when the electronic device 100 transmits and receives an RF signal of a second frequency band through the antenna 130.

For example, the processor 110 may select one of the second band tune codes BTC2s based on the reflection coefficient measured from the antenna 130, when the electronic device 100 transmits and receives the RF signal of the second frequency band through the antenna 130.

According to an example embodiment, the processor 110 may select one of the third band tune codes BTC3s when the electronic device 100 transmits and receives an RF signal of a third frequency band through the antenna 130.

For example, the processor 110 may select one of the third band tune codes BTC3s based on the reflection coefficient measured from the antenna 130, when the electronic device 100 transmits and receives the RF signal of the third frequency band through the antenna 130.

Furthermore, the processor 110 may control the tuning circuit 120B using the selected tune code.

Referring to the above-described configurations, the processor 110 may identify each of a plurality of band tune codes BTC1s, BTC2s, and BTC3s that are valid for each frequency band, among the plurality of valid tune codes VTCs, based on prestored band rules corresponding to each frequency band.

Furthermore, the processor 110 may control the tuning circuit 120B using one of the plurality of band tune codes BTC1s, BTC2s, and BTC3s identified for each frequency band, according to the frequency band of the RF signal transmitted and received through the antenna 130.

As a result, the electronic device 100 according to an example embodiment may reduce the time and costs required to select a valid tune code depending on the frequency band.

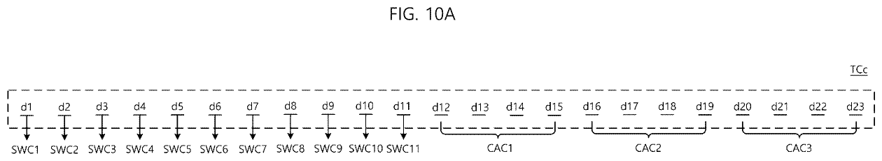

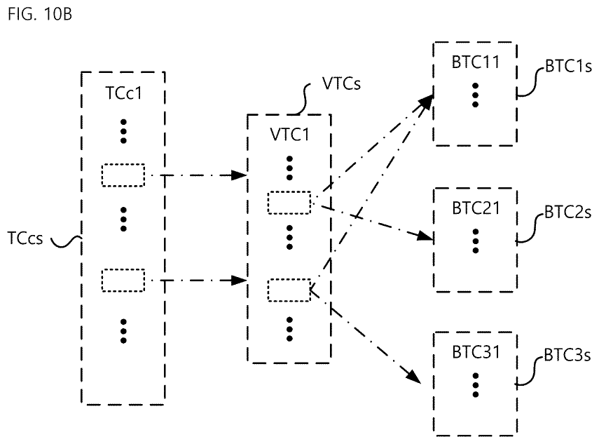

FIG. 9 is a circuit diagram illustrating a tuning circuit according to an example embodiment. FIG. 10A is a diagram illustrating a tune code including bits corresponding to a plurality of elements included in a tuning circuit according to an example embodiment. FIG. 10B is a diagram illustrating a configuration to identify band tune codes of each frequency band from a plurality of tune codes according to an example embodiment.

Referring to FIG. 9, a tuning circuit 120C according to an example embodiment may include a plurality of elements.

For example, the tuning circuit 120C may include a first switch SWC1 to an eleventh switch SWC11, a first capacitor array CAC1, a second capacitor array CAC2, and a third capacitor array CAC3.

The tuning circuit 120C and a tune code TCc illustrated in FIG. 9 may be understood as examples of the tuning circuit 120 and the tune code TC illustrated in FIG. 1, respectively. Therefore, the same or substantially the same components are represented by the same reference numerals, and redundant descriptions will be omitted to avoid repetition.

According to an example embodiment, the tuning circuit 120C may include a plurality of pads P1 to P14 connected to an external configuration of the tuning circuit 120C.

For example, the tuning circuit 120C may include a third pad P3, a fifth pad P5, and a seventh pad P7 connected to an antenna 130. For example, the tuning circuit 120C may include a twelfth pad P12 receiving the tune code TCc from a processor 110.

For example, the tuning circuit 120C may include a thirteenth pad P13 connected to a first inductor L1. Also, the tuning circuit 120C may include an eleventh pad P11 connected to a second inductor L2. Also, the tuning circuit 120C may include a ninth pad P9 connected to a third inductor L3.

Also, the tuning circuit 120C may include a plurality of switches SWC1 to SWC11.

For example, the tuning circuit 120C may include a first switch SWC1 connected to the twelfth pad P12. Also, the tuning circuit 120C may include a second switch SWC2 connected between the thirteenth pad P13 and the twelfth pad P12. Also, the tuning circuit 120C may include a third switch SWC3 connected between the twelfth pad P12 and the eleventh pad P11. Also, the tuning circuit 120C may include a fourth switch SWC4 connected between a fourteenth pad P14 and a first pad P1. Also, the tuning circuit 120C may include a fifth switch SWC5 connected between a ninth pad P9 and a tenth pad P10. Also, the tuning circuit 120C may include a sixth switch SW C6 connected to the fifth pad P5. Also, the tuning circuit 120C may include a seventh switch SWC7 connected between a fourth pad P4 and a fifth pad P5. Also, the tuning circuit 120C may include an eighth switch SWC8 connected between the fifth pad P5 and a sixth pad P6. Also, the tuning circuit 120C may include a ninth switch SWC9 connected between a third pad P3 and a second pad P2. Also, the tuning circuit 120C may include a tenth switch SWC10 connected between the seventh pad P7 and the eighth pad P8. Also, the tuning circuit 120C may include an eleventh switch SWC11 connected between the first switch SWC1 and the sixth switch SWC6.

According to an example embodiment, each of the sixth switch SWC6, the seventh switch SWC7, the eighth switch SWC8, the ninth switch SWC9, and the tenth switch SWC10 may be electrically separated from an electrical path connected from the processor 110 (through the RF front end 150) to the antenna 130.

Accordingly, each of the sixth switch SWC6, the seventh switch SWC7, the eighth switch SWC8, the ninth switch SWC9, and the tenth switch SWC10 may be referred to as an invalid element.

Also, the tuning circuit 120C may include a first capacitor array CAC1, a second capacitor array CAC2, and a third capacitor array CAC3.

For example, the tuning circuit 120C may include the first capacitor array CAC1 connected between the twelfth pad P12 and the eleventh switch SWC11.

According to an example embodiment, the first capacitor array CAC1 may include five unit capacitors, connected in parallel, and four unit switches connected in series with four of the five unit capacitors, respectively.

The first capacitor array CAC1 may be connected in parallel to the first switch SWC1.

Also, the tuning circuit 120C may include a second capacitor array CAC2 connected between the first pad P1 and the ground.

According to an example embodiment, the second capacitor array CAC2 may include five unit capacitors, connected in parallel, and four unit switches connected in series with four of the five unit capacitors, respectively.

Also, the tuning circuit 120C may include a third capacitor array CAC3 connected between the fifth pad P5 and the eleventh switch SWC11. The third capacitor array CAC3 may be connected in parallel to the sixth switch SWC6.

According to an example embodiment, the third capacitor array CAC3 may be electrically separated from the electrical path connected from the processor 110 (through the RF front end 150) to the antenna 130. Therefore, the third capacitor array CAC3 may be referred to as an invalid element.

Referring to FIG. 10A, the tune code TCc according to an example embodiment may include a plurality of bits d1 to d23, respectively corresponding to the plurality of elements included in the tuning circuit 120C.

According to an example embodiment, the tune code TCc may include a first bit d1 to an eleventh bit d11, respectively corresponding to the first switch SWC1 to the eleventh switch SWC11.

For example, the tune code TCc may include a first bit d1 corresponding to the first switch SWC1. Also, the tune code TCc may include a third bit d3 corresponding to the third switch SWC3.

According to an example embodiment, the tune code TCc may include a twelfth bit d12 to a fifteenth bit d15 corresponding to the first capacitor array CAC1.

The twelfth bit d12 to the fifteenth bit d15 corresponding to the first capacitor array CAC1 may be referred to as first capacitor bits. Also, the twelfth bit d12 to the fifteenth bit d15 may be understood as constituting a 4-bit first capacitor code corresponding to the first capacitor array CAC1.

According to an example embodiment, the tune code TCc may include a sixteenth bit d16 to a nineteenth bit d19 corresponding to the second capacitor array CAC2.

For example, the tune code TCc may include the sixteenth bit d16 to the nineteenth bit d19, respectively corresponding to a plurality of unit switches included in the second capacitor array CAC2.

The sixteenth bit d16 to the nineteenth bit d19 corresponding to the second capacitor array CAC2 may be referred to as second capacitor bits. Also, the sixteenth bit d16 to the nineteenth bit d19 may be understood as constituting a 4-bit second capacitor code corresponding to the second capacitor array CAC2.

According to an example embodiment, the tune code TCc may include a twentieth bit d20 to a twenty-third bit d23 corresponding to the third capacitor array CAC3.

For example, the tune code TCc may include the twentieth bit d20 to the twenty-third bit d23, respectively corresponding to a plurality of unit switches included in the third capacitor array CAC3.

The twentieth bit d20 to the twenty-third bit d23 corresponding to the third capacitor array CAC3 may be referred to as third capacitor bits. Also, the twentieth bit d20 to the twenty-third bit d23 may be understood as constituting a 4-bit third capacitor code corresponding to the third capacitor array CAC3.

According to an example embodiment, the processor 110 may control the tuning circuit 120C using the tune code TCc including the plurality of bits d1 to d23.

For example, the processor 110 may control the plurality of elements included in the tuning circuit 120C using the tune code TCc including the plurality of bits d1 to d23.

For example, the processor 110 may turn on the first switch SWC1 of the tuning circuit 120C using a tune code TCc in which the value of the first bit d1 is “1.”

For example, the processor 110 may control the capacitance of the first capacitor array CAC1 by setting each of the twelfth bit d12 to the fifteenth bit d15 to “0” or “1.”

For example, the processor 110 may control the capacitance of the second capacitor array CAC2 by setting each of the sixteenth bit d16 to the nineteenth bit d19 to “0” or “1.”

For example, the processor 100 may control the capacitance of the third capacitor array CAC3 by setting each of the twentieth bit d20 to the twenty-third bit d23 to “0” or “1.”

As a result, the processor 110 may control the impedance of the tuning circuit 120C.

Referring to FIG. 10B, the processor 110 according to an example embodiment may generate a plurality of tune codes TCcs based on information on a plurality of elements included in the tuning circuit 120C.

For example, the processor 110 may generate a plurality of tune codes TCcs having different values based on the information on the plurality of elements included in the tuning circuit 120C.

For example, the information on the plurality of elements included in the tuning circuit 120C may include first information including an arrangement and a connection relationship of the plurality of elements.

Also, the information on the plurality of elements included in the tuning circuit 120C may include second information on an element, corresponding to each of the plurality of bits d1 to d23, among the plurality of elements.

Therefore, the electronic device 100 according to an example embodiment may further include an interface for receiving the information on the plurality of elements. The electronic device 100 may further include a memory (or a memory device) storing the input information on the plurality of elements.

Each of the plurality of bits d1 to d23 may have a value of “0” or “1” represented in binary. Accordingly, for example, when the tune code TCc includes 14 bits, the processor 110 may generate 2¹⁴-1 tune codes TCcs.

The processor 110 according to an example embodiment may identify a plurality of valid tune codes VTCs satisfying a default rule, among the plurality of tune codes TCcs.

For example, the processor 110 may identify a plurality of valid tune codes VTCs satisfying a default rule set for at least some of the plurality of bits d1 to d23, among the plurality of tune codes TCcs.

According to an example embodiment, information (or data) on the default rule may be stored in a memory (or a memory device) provided in the electronic device 100.

According to an example embodiment, the default rule may include a first default rule in which the eleventh bit d11 has a predetermined value (for example, “1”).

For example, the default rule may include a first default rule in which the eleventh bit d11 corresponding to the eleventh switch SWC11 has a predetermined first value (for example, “1”). When the eleventh switch SWC11 is turned off, the electrical path connected from the processor 110 (through the RF front end 150) to the antenna 130 may be interrupted.

For example, the processor 110 may identify a tune code satisfying a first default rule in which the eleventh bit d11 corresponding to the eleventh switch SWC11 has a predetermined first value (for example, “1”) such that the eleventh switch SWC11 connected to the antenna 130 is maintained in an ON state. Also, the default rule may include a second default rule in which the sixteenth bit d16 to the nineteenth bit d19 have a predetermined value when the fourth bit d4 has a second value.

For example, the default rule may include a second default rule in which the sixteenth bit d16 to the nineteenth bit d19 corresponding to the second capacitor array CAC2 have a predetermined value (for example, “0000”) when the fourth bit d4 corresponding to the fourth switch SWC4 has a second value (for example, “0”).

The fourth switch SWC4 and the second capacitor array CAC2 may be connected in series between the processor 110 and the ground. For example, when the fourth switch SWC4 is in an OFF state, whether or not the second capacitor array CAC2 is driven may not affect the electrical path connected from the processor 110 (through the RF front end 150) to the antenna 130.

Accordingly, the processor 110 may identify a tune code satisfying a second default rule in which the sixteenth bit d16 to the nineteenth bit d19 corresponding to the second capacitor array CAC2 have a predetermined value (for example, “0”) when the fourth bit d4 corresponding to the fourth switch SWC4 has a second value (for example, “0”).

Also, the default rule may include a third default rule in which the twelfth bit d12 to the fifteenth bit d15 have a predetermined value, when the first bit d1 has a first value.

For example, the default rule may include a third default rule in which the twelfth bit d12 to the fifteenth bit d15 corresponding to the first capacitor array CAC1 have a predetermined value (for example, “0”) when the first bit d1 corresponding to the first switch SWC1 has a first value (for example, “1”).

The first switch SWC1 and the first capacitor array CAC1 may be connected in parallel in the electrical path connected from the processor 110 to the antenna 130 (through the RF front end 150). For example, when the first switch SWC1 is in an ON state, the capacitance of the first capacitor array CAC1 may not affect the electrical path connected from the processor 110 to the antenna 130 (through the RF front end 150).

Accordingly, the processor 110 may identify a tune code satisfying a third default rule in which each of the twelfth bit d12 to the fifteenth bit d15 corresponding to the first capacitor array CAC1 has a predetermined value (for example, “0”) when the first switch SWC1 is in an ON state.

Also, the default rule may include a fourth default rule in which the twentieth bit d20 to the twenty-third bit d23 have a predetermined value.

For example, the default rule may include a fourth default rule in which the twentieth bit d20 to the twenty-third bit d23 corresponding to the third capacitor array CAC3 have a predetermined value (for example, “0”).

According to an example embodiment, the third capacitor array CAC3 may be understood as an invalid element, electrically separated from the electrical path connected from the processor 110 (through the RF front end 150) to the antenna 130. Also, the twentieth bit d20 to the twenty-third bit d23 corresponding to the third capacitor array CAC3 may be referred to as invalid bits.

For example, the magnitude of the capacitance of the third capacitor array CAC3 may not electrically affect the electrical path connected from the processor 110 (through the RF front end 150) to the antenna 130.

Accordingly, the processor 110 may identify a tune code satisfying a fourth default rule in which each of the twentieth bit d20 to the twenty-third bit d23 corresponding to the third capacitor array CAC3 has a predetermined value (for example, “0”).

Also, the default rule may include a fifth default rule in which the sixth bit d6 to the tenth bit d10 have a predetermined value.

For example, the default rule may include a fifth default rule in which the sixth bit d6 to the tenth bit d10 corresponding to the sixth switch SWC6 to the tenth switch SWC10 have a predetermined value (for example, “0”).

According to an example embodiment, each of the sixth switch SWC6 to the tenth switch SWC10 may be understood as an invalid element, electrically separated from the electrical path connected from the processor 110 (through the RF front end 150) to the antenna 130. The sixth bit d6 to the tenth bit d10, respectively corresponding to the sixth switch SWC6 to the tenth switch SWC10, may be referred to as invalid bits.

For example, whether or not the sixth switch SWC6 to the tenth switch SWC10 are turned on may not electrically affect the electrical path connected from the processor 110 (through the RF front end 150) to the antenna 130.

Accordingly, the processor 110 may identify a tune code satisfying a fifth default rule in which each of the sixth bit d6 to the tenth bit d10 corresponding to the sixth switch SWC6 to the tenth switch SWC10, which are invalid elements, has a predetermined value (for example, “0”).

As a result, the processor 110 (or the electronic device) 100 may reduce the time and costs required for impedance matching due to tune codes in which invalid bits corresponding to invalid elements, which do not affect the impedance of the antenna 130, have different values.

Referring to the above-described configurations, the processor 110 may identify a plurality of valid tune codes VTCs for controlling the tuning circuit 120C based on information related to the tuning circuit 120C and a prestored default rule.

For example, the processor 110 may identify a plurality of valid tune codes VTCs other than tune codes interrupting a valid electrical path or having redundant circuitry.

As a result, the electronic device 100 according to an example embodiment may significantly reduce the time and costs required for impedance matching due to tune codes interrupting a valid electrical path or having redundant circuitry.

Also, the processor 110 may identify a band tune code that is valid for each of the first frequency band to the third frequency band, among the plurality of valid tune codes VTCs.

For example, the first frequency band may be referred to as a frequency band of less than about 1 GHz. For example, the second frequency band may be referred to as a frequency band of about 1 GHz or more to less than about 2 GHz. For example, the third frequency band may be referred to as a frequency band of about 2.3 GHz or more to less than 3 GHz. However, each frequency band is not limited to the above-mentioned examples.

For example, the processor 110 may identify band tune codes satisfying a band rule set for each frequency band, among the plurality of valid tune codes VTCs.

According to an example embodiment, the processor 110 may identify first band tune codes BTC1s that are valid for the first frequency band, among the plurality of valid tune codes VTCs.

According to an example embodiment, the processor 110 may identify first band tune codes BTC1s satisfying a first band rule set for the first frequency band, among the plurality of valid tune codes VTCs.

The processor 110 may identify first band tune codes BTC1s satisfying a first band rule set for bits corresponding to the first capacitor array CAC1, among the plurality of valid tune codes VTCs.

The first band rule may include, wherein a first capacitor code, including bits corresponding to the first capacitor array CAC1, has a value greater than or equal to a first lower limit code.

For example, the first band rule may include, wherein the first capacitor code has a value greater than or equal to the first lower limit code corresponding to the first lower limit value such that the first capacitor array CAC1 has a capacitance greater than or equal to a first lower limit value set for the first frequency band.

For example, the first band rule may include, wherein the first capacitor code, including the twelfth bit d12 to the fifteenth bit d15, has a value of “1000” or more. For example, the processor 110 may determine that a tune code having a first capacitor code of “1010,” among the plurality of valid tune codes VTCs, satisfies the first band rule.

According to an example embodiment, the first band rule may further include an inductor rule in which at least one of the bits corresponding to switches connected to the inductor (for example, the second switch SWC2, the third switch SWC3, and the fifth switch SWC5) has a first value (for example, “0”).

For example, the first band rule may further include an inductor rule in which at least one of the second bit d2, the third bit d3, and the fifth bit d5 corresponding to switches connected to the inductor is “0.”

For example, the processor 110 may identify first band tune codes BTC1s, among the plurality of valid tune codes VTCs, in which at least one of the second bit d2, the third bit d3, and the fifth bit d5 is “0” and the first capacitor code has a value of “1000” or more.

Also, the processor 110 according to an example embodiment may identify second band tune codes BTC2s that are valid for the second frequency band, among the plurality of valid tune codes VTCs.

The processor 110 according to an example embodiment may identify second band tune codes BTC2s satisfying a second band rule set for the second frequency band, among the plurality of valid tune codes VTCs.

The processor 110 may identify second band tune codes BTC2s satisfying a second band rule set for bits corresponding to the first capacitor array CAC1 and the second capacitor array CAC2, among the plurality of valid tune codes VTCs.

The second band rule may include a (2-1)th band rule in which the first capacitor code has a value greater than or equal to a second lower limit code smaller than the first lower limit code.

For example, the second band rule may include a (2-1)th band rule in which the first capacitor code has a value greater than or equal to a second lower limit code corresponding to a second lower limit value smaller than the first lower limit value such that the first capacitor array CAC1 has a capacitance greater than or equal to the second lower limit value.

For example, the (2-1)th band rule may include that the first capacitor code, including the twelfth bit d12 to the fifteenth bit d15, has a value of “0100” or more. For example, the processor 110 may determine that a tune code having a first capacitor code of “0110,” among the plurality of valid tune codes VTCs, satisfies the (2-1)th band rule.

Also, the second band rule according to an example embodiment may include a (2-2)band rule in which the second capacitor code has a value less than or equal to a first upper limit code. The second capacitor code may be understood as a code including bits corresponding to the second capacitor array CAC2, among the plurality of bits d1 to d23.

For example, the second band rule may include a (2-2)th band rule in which the second capacitor code has a value less than or equal to a first upper limit code corresponding to a first upper limit value such that the second capacitor array CAC2 has a capacitance less than or equal to the first upper limit value.

For example, the (2-2)th band rule may include, wherein the second capacitor code, including the sixteenth bit d16 to the nineteenth bit d19, has a value less than “1000”. For example, the processor 110 may determine that a tune code having a second capacitor code of “0100,” among the plurality of valid tune codes VTCs, satisfies the (2-2)th band rule.

For example, the processor 110 may identify second band tune codes BTC2s in which the first capacitor code has a value of “0100” or more and the second capacitor code has a value less than “1000,” among the plurality of valid tune codes VTCs.

Also, the processor 110 according to an example embodiment may identify third band tune codes BTC3s that are valid for the third frequency band, among the plurality of valid tune codes VTCs.

According to an example embodiment, the processor 110 may identify third band tune codes BTC3s satisfying a third band rule set for the third frequency band, among the plurality of valid tune codes VTCs.

The processor 110 may identify third band tune codes BTC3s satisfying a third band rule set for bits corresponding to the first capacitor array CAC1, among the plurality of valid tune codes VTCs.

The third band rule may include, wherein the first capacitor code has a value greater than or equal to a third lower limit code smaller than the second lower limit code.

For example, the third band rule may include, wherein the first capacitor code has a value greater than or equal to a third lower limit code corresponding to a third lower limit value set for the third frequency band such that the first capacitor array CAC1 has a capacitance greater than or equal to the third lower limit value.

For example, the third band rule may include, wherein the first capacitor code composed of the twelfth bit d12 to the fifteenth bit d15 has a value of “0010” or more. For example, the processor 110 may determine that a tune code having a first capacitor code of “0011,” among the plurality of valid tune codes VTCs, satisfies the third band rule.

Also, the third band rule may include, wherein each of the bits b16 to b16 corresponding to the second capacitor array CAC2 has a value of “0.”

For example, the processor 110 may identify second band tune codes BTC2s in which the first capacitor code has a value of “0010” or more and the second capacitor code is “0000,” among the plurality of valid tune codes VTCs.

According to an example embodiment, the electronic device 100 may further include a memory (or a memory device) storing the first band rule, the second band rule, and the third band rule. Furthermore, the memory (or the memory device) may store the first band tune codes BTC1s, the second band tune codes BTC2s, and the third band tune codes BTC3s.

The processor 110 may control the tuning circuit 120B using one of the band tune codes identified for each frequency band when the electronic device 100 transmits or receives an RF signal of a predetermined frequency band through the antenna 130.

According to an example embodiment, the processor 110 may select one of the first band tune codes BTC1s when the electronic device 100 transmits or receives an RF signal of the first frequency band through the antenna 130.

For example, when the electronic device 100 transmits or receives an RF signal of the first frequency band through the antenna 130, the processor 110 may select one of the first band tune codes BTC1s based on a reflection coefficient measured from the antenna 130.

According to an example embodiment, the processor 110 may select one of the second band tune codes BTC2s when the electronic device 100 transmits or receives an RF signal of a second frequency band through the antenna 130.

For example, when the electronic device 100 transmits or receives an RF signal of the second frequency band through the antenna 130, the processor 110 may select one of the second band tune codes BTC2s based on the reflection coefficient measured from the antenna 130.

According to an example embodiment, the processor 110 may select one of the third band tune codes BTC3s when the electronic device 100 transmits or receives an RF signal of the third frequency band through the antenna 130.

For example, when the electronic device 100 transmits or receives an RF signal of the third frequency band through the antenna 130, the processor 110 may select one of the third band tune codes BTC3s based on the reflection coefficient measured from the antenna 130.

Furthermore, the processor 110 may control the tuning circuit 120C using the selected tune code.

Referring to the above-described configurations, the processor 110 may identify the plurality of band tune codes BTC1s, BTC2s, BTC3s that are valid for each frequency band, among the plurality of valid tune codes VTCs, based on the pre-stored band rules corresponding to each frequency band.

Furthermore, the processor 110 may control the tuning circuit 120C using one of the plurality of band tune codes BTC1s, BTC2s, BTC3s identified for each frequency band, depending on the frequency band of the RF signal transmitted or received through the antenna 130.

As a result, the electronic device 100 according to an example embodiment may reduce the time and costs required to select a valid tune code depending on the frequency band.

Also, referring to the above-described configurations, the electronic device 100 may prevent the tuning circuit 120C from being controlled by tune codes invalid for each frequency band.

As a result, the electronic device 100 according to an example embodiment may significantly reduce the degradation of the performance of transmitting and receiving RF signals through the antenna 130.

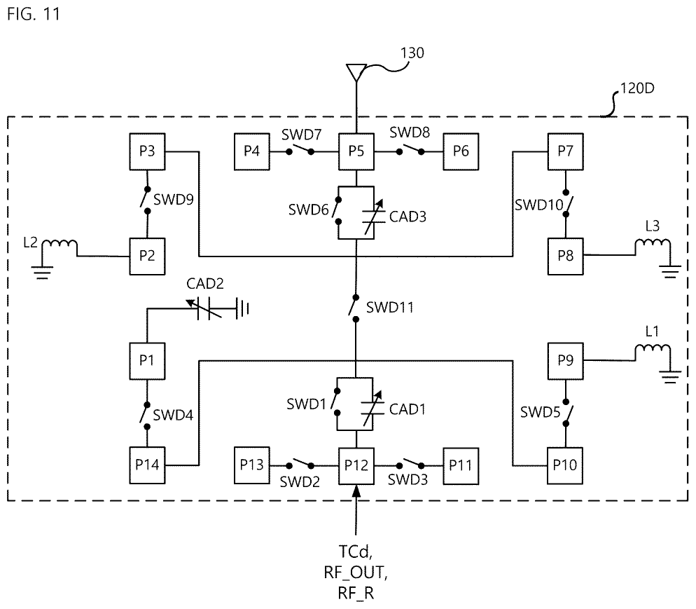

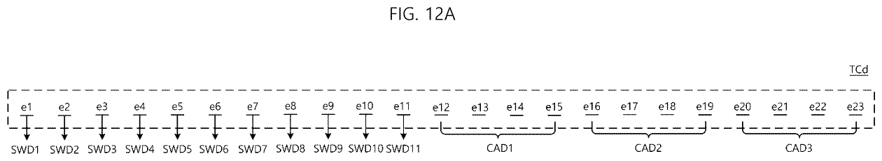

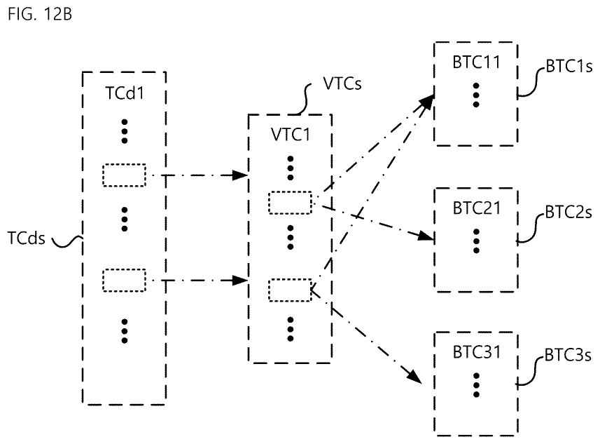

FIG. 11 is a circuit diagram of a tuning circuit according to an example embodiment. FIG. 12A is a diagram illustrating a tune code including bits corresponding to a plurality of elements included in a tuning circuit according to an example embodiment. FIG. 12B is a diagram illustrating a configuration to identify band tune codes of each frequency band from a plurality of tune codes according to an example embodiment.

Referring to FIG. 11, a tuning circuit 120D according to an example embodiment may include a plurality of elements.

For example, the tuning circuit 120D may include a first switch SWD1 to an eleventh switch SWD11, a first capacitor array CAD1, a second capacitor array CAD2, and a third capacitor array CAD3.

The tuning circuit 120D illustrated in FIG. 11 and the tune code TCd may be understood as examples of the tuning circuit 120 and the tune code TC illustrated in FIG. 1, respectively. Therefore, the same or substantially the same components are represented by the same reference numerals, and redundant descriptions will be omitted to avoid repetition.

According to an example embodiment, the tuning circuit 120D may include a plurality of pads P1 to P14 connected to an external configuration of the tuning circuit 120D.

For example, the tuning circuit 120D may include a fifth pad P5 connected to an antenna 130. For example, the tuning circuit 120D may also include a twelfth pad P12 receiving a tune code TCd from the processor 110.

For example, the tuning circuit 120D may include a fifth pad P5 connected to a first inductor L1. Also, the tuning circuit 120D may include a ninth pad P9 connected to a second inductor L2. Also, the tuning circuit 120D may include a tenth pad P10 connected to a third inductor L3.

Also, the tuning circuit 120D may include a plurality of switches SWD1 to SWD11.

For example, the tuning circuit 120D may include a first switch SWD1 connected to the twelfth pad P12. Also, the tuning circuit 120D may include a second switch SW D2 connected between the thirteenth pad P13 and the twelfth pad P12. Also, the tuning circuit 120D may include a third switch SWD3 connected between the twelfth pad P12 and the eleventh pad P11. Also, the tuning circuit 120D may include a fourth switch SWD4 connected between the fourteenth pad P14 and the first pad P1. Also, the tuning circuit 120D may include a fifth switch SWD5 connected between the ninth pad P9 and the tenth pad P10. Also, the tuning circuit 120D may include a sixth switch SWD6 connected to the fifth pad P5. Also, the tuning circuit 120D may include a seventh switch SWD7 connected between the fourth pad P4 and the fifth pad P5. Also, the tuning circuit 120D may include an eighth switch SWD8 connected between the fifth pad P5 and the sixth pad P6. Also, the tuning circuit 120D may include a ninth switch SWD9 connected between the third pad P3 and the second pad P2. Also, the tuning circuit 120D may include a tenth switch SWD10 connected between the seventh pad P7 and the eighth pad P8. Also, the tuning circuit 120D may include an eleventh switch SWD11 connected between the first switch SWD1 and the sixth switch SWD6.

According to an example embodiment, the second switch SWD2, the third switch SWD3, the seventh switch SWD7, and the eighth switch SWD8 may be electrically separated from an electrical path connected from the processor 110 (through the RF front end 150) to the antenna 130.

Therefore, the second switch SWD2, the third switch SWD3, the seventh switch SWD7, and the eighth switch SWD8 may be referred to as invalid elements.

Also, the tuning circuit 120D may include a first capacitor array CAD1, a second capacitor array CAD2, and a third capacitor array CAD3.

For example, the tuning circuit 120D may include a first capacitor array CAD1 connected between the twelfth pad P12 and the eleventh switch SWD11.

According to an example embodiment, the first capacitor array CAD1 may include five unit capacitors, connected in parallel, and four unit switches connected in series with four of the five unit capacitors, respectively.

The first capacitor array CAD1 may be connected in parallel to the first switch SWD1.

The tuning circuit 120D may include a second capacitor array CAD2 connected between the first pad P1 and ground.

According to an example embodiment, the second capacitor array CAD2 may include five unit capacitors, connected in parallel, and four unit switches connected in series with four of the five unit capacitors, respectively.

Also, the tuning circuit 120D may include a third capacitor array CAD3 connected between the fifth pad P5 and the eleventh switch SWD11. The third capacitor array CAD3 may be connected in parallel to the sixth switch SWD6.

Referring to FIG. 12A, a tune code TCd according to an example embodiment may include a plurality of bits e1 to e23 corresponding to each of a plurality of elements included in the tuning circuit 120D.

According to an example embodiment, the tune code TCd may include a first bit e1 to an eleventh bit e11, respectively corresponding to the first switch SWD1 to the eleventh switch SWD11.

For example, the tune code TCd may include a first bit e1 corresponding to the first switch SWD1.

According to an example embodiment, the tune code TCd may include a twelfth bit e12 to a fifteenth bit e15 corresponding to the first capacitor array CAD1.

The twelfth bit e12 to the fifteenth bit e15 corresponding to the first capacitor array CAD1 may be referred to as first capacitor bits. Also, the twelfth bit e12 to the fifteenth bit e15 may be understood as constituting a 4-bit first capacitor code corresponding to the first capacitor array CAD1.

According to an example embodiment, the tune code TCd may include a sixteenth bit e16 to a nineteenth bit e19 corresponding to the second capacitor array CAD2.

For example, the tune code TCd may include the sixteenth bit e16 to the nineteenth bit e19, respectively corresponding to a plurality of unit switches included in the second capacitor array CAD2.

The sixteenth bit e16 to the nineteenth bit e19 corresponding to the second capacitor array CAD2 may be referred to as second capacitor bits. Also, the sixteenth bit e16 to the nineteenth bit e19 may be understood as constituting a 4-bit second capacitor code corresponding to the second capacitor array CAD2.

According to an example embodiment, the tune code TCd may include a twentieth bit e20 to a twenty-third bit e23 corresponding to the third capacitor array CAD3.

For example, the tune code TCd may include the twentieth bit e20 to the twenty-third bit e23, respectively corresponding to a plurality of unit switches included in the third capacitor array CAD3.

The twentieth bit e20 to the twenty-third bit e23 corresponding to the third capacitor array CAD3 may be referred to as third capacitor bits. Also, the twentieth bit e20 to the twenty-third bit e23 may be understood as constituting a 4-bit third capacitor code corresponding to the third capacitor array CAD3.

According to an example embodiment, the processor 110 may control the tuning circuit 120D using a tune code TCd including a plurality of bits e1 to e23.

For example, the processor 110 may control a plurality of elements included in the tuning circuit 120D using the tune code TCd including a plurality of bits e1 to e23.

For example, the processor 110 may turn on the first switch SWD1 of the tuning circuit 120D using a tune code TCd in which a value of the first bit e1 is “1.”

For example, the processor 110 may control the capacitance of the first capacitor array CAD1 by setting each of the twelfth bit e12 to the fifteenth bit e15 to “0” or “1.”

For example, the processor 110 may control the capacitance of the second capacitor array CAD2 by setting each of the sixteenth bit e16 to the nineteenth bit e19 to “0” or “1.”

For example, the processor 110 may control the capacitance of the third capacitor array CAD3 by setting each of the twentieth bit e20 to the twenty-third bit e23 to “0” or “1.”

As a result, the processor 110 may control the impedance of the tuning circuit 120D.

Referring to FIG. 12B, the processor 110 according to an example embodiment may generate a plurality of tune codes TCds based on information on a plurality of elements included in the tuning circuit 120D.

For example, the processor 110 may generate a plurality of tune codes TCds having different values based on information on the plurality of elements included in the tuning circuit 120D.

For example, the information on the plurality of elements included in the tuning circuit 120D may include first information including an arrangement and a connection relationship of the plurality of elements.

Also, the information on the plurality of elements included in the tuning circuit 120D may include second information on an element corresponding to each of the plurality of bits e1 to e23, among the plurality of elements.

Therefore, the electronic device 100 according to an example embodiment may further include an interface for receiving the information on the plurality of elements. The electronic device 100 may further include a memory (or a memory device) storing the input information on the plurality of elements.

Each of the plurality of bits e1 to e23 may have a value of “0” or “1” represented in binary. Therefore, for example, when the tune code TCd includes 14 bits, the processor 110 may generate 2¹⁴-1 tune codes TCds.

According to an example embodiment, the processor 110 may identify a plurality of valid tune codes VTCs satisfying default rules, among the plurality of tune codes TCds.

For example, the processor 110 may identify a plurality of valid tune codes VTCs satisfying default rules set for at least a portion of the plurality of bits e1 to e23, among the plurality of tune codes TCds.

According to an example embodiment, information (or data) on the default rules may be stored in a memory (or a memory device) provided in the electronic device 100.

According to an example embodiment, the default rules may include a first default rule in which the eleventh bit e11 has a predetermined value (for example, “1”).

For example, the default rules may include a first default rule in which the eleventh bit e11 corresponding to the eleventh switch SWD11 has a predetermined first value (for example, “1”). When the eleventh switch SWD11 is turned off, the electrical path connected from the processor 110 (through the RF front end 150) to the antenna 130 may be interrupted.

For example, the processor 110 may identify a tune code satisfying the first default rule in which the eleventh bit e11 corresponding to the eleventh switch SWD11 has a predetermined first value (for example, “1”) such that the eleventh switch SWD11 connected to the antenna 130 is maintained in an ON state.

Also, the default rules may include a second default rule in which the sixteenth bit e16 to the nineteenth bit e19 have a predetermined value when the fourth bit e4 has a second value.

For example, the default rules may include a second default rule in which the sixteenth bit e16 to the nineteenth bit e19 corresponding to the second capacitor array CAD2 have a predetermined value (for example, “0000”) when the fourth bit e4 corresponding to the fourth switch SWD4 has a second value (for example, “0”).

The fourth switch SWD4 and the second capacitor array CAD2 may be connected in series between the processor 110 and ground. For example, when the fourth switch SWD4 is in an OFF state, whether the second capacitor array CAD2 operates may not affect the electrical path connected from the processor 110 (through the RF front end 150) to the antenna 130.

Accordingly, the processor 110 may identify a tune code satisfying the second default rule in which the sixteenth bit e16 to the nineteenth bit e19 corresponding to the second capacitor array CAD2 have a predetermined value (for example, “0”) when the fourth switch SWD4 is in an OFF state.

Also, the default rules may include a third default rule in which the twelfth bit e12 to the fifteenth bit e15 have a predetermined value when the first bit e1 has a first value.

For example, the default rules may include a third default rule in which the twelfth bit e12 to the fifteenth bit e15 corresponding to the first capacitor array CAD1 have a predetermined value (for example, “0”) when the first bit e1 corresponding to the first switch SWD1 has a first value (for example, “1”).

The first switch SWD1 and the first capacitor array CAD1 may be connected in parallel in the electrical path connected from the processor 110 (through the RF front end 150) to the antenna 130. For example, when the first switch SWD1 is in an ON state, the capacitance of the first capacitor array CAD1 may not affect the electrical path connected from the processor 110 (through the RF front end 150) to the antenna 130.

Accordingly, the processor 110 may identify a tune code satisfying the third default rule in which each of the twelfth bit e12 to the fifteenth bit e15 corresponding to the first capacitor array CAD1 have a predetermined value (for example, “0”) when the first switch SWD1 is in an ON state.

Also, the default rules may include a fourth default rule in which the twentieth bit e20 to the twenty-third bit e23 have a predetermined value when the sixth bit e6 has a first value.

For example, the default rules may include a fourth default rule in which the twentieth bit e20 to the twenty-third bit e23 corresponding to the third capacitor array CAD3 have a predetermined value (for example, “0”) when the sixth bit e6 corresponding to the sixth switch SWD6 has a first value (for example, “1”).

The sixth switch SWD6 and the third capacitor array CAD3 may be connected in parallel in the electrical path connected from the processor 110 (through the RF front end 150) to the antenna 130. For example, when the sixth switch SWD6 is in an ON state, the capacitance of the third capacitor array CAD3 may not affect the electrical path connected from the processor 110 (through the RF front end 150) to the antenna 130.

Accordingly, the processor 110 may identify a tune code satisfying the fourth default rule in which each of the twentieth bit e20 to the twenty-third bit e23 corresponding to the third capacitor array CAD3 have a predetermined value (for example, “0”) when the sixth switch SWD6 is in an ON state.

Also, the default rules may include a fifth default rule in which the second bit e2, third bit e3, seventh bit e7, and eighth bit e8 have predetermined values.

For example, the default rules may include a fifth default rule in which the second bit e2, third bit e3, seventh bit e7, and eighth bit e8, respectively corresponding to the second switch SWD2, third switch SWD3, seventh switch SWD7, and eighth switch SWD8, have a predetermined value (for example, “0”).

According to an example embodiment, the second switch SWD2, third switch SWD3, seventh switch SWD7, and eighth switch SWD8 may be understood as invalid elements, electrically separated from the electrical path connected from the processor 110 (through the RF front end 150) to the antenna 130. The second bit e2, third bit e3, seventh bit e7, and eighth bit e8, respectively corresponding to the second switch SWD2, third switch SWD3, seventh switch SWD7, and eighth switch SWD8, may be referred to as invalid bits.

For example, whether the second switch SWD2, third switch SWD3, seventh switch SWD7, and eighth switch SWD8 are turned on may not electrically affect the electrical path connected from the processor 110 (through the RF front end 150) to the antenna 130.

Accordingly, the processor 110 may identify a tune code satisfying the fifth default rule in which the second bit e2, third bit e3, seventh bit e7, and eighth bit e8, respectively corresponding to the second switch SWD2, third switch SWD3, seventh switch SWD7, and eighth switch SWD8 that are invalid elements, have a predetermined value (for example, “0”).

As a result, the processor 110 (or the electronic device 100) may reduce the time and costs required for impedance matching due to tune codes in which invalid bits corresponding to the invalid elements, which do not affect the impedance of the antenna 130, have different values.

Referring to the above-described configurations, the processor 110 may identify a plurality of valid tune codes VTCs, among a plurality of tune codes TCds for controlling the tuning circuit 120D, based on information related to the tuning circuit 120D and a prestored default rule.

For example, the processor 110 may identify a plurality of valid tune codes VTCs other than a plurality of tune codes interrupting a valid electrical path or having redundant circuitry.

As a result, the electronic device 100 according to an example embodiment may significantly reduce the time and costs required for impedance matching due to tune codes interrupting a valid electrical path or having redundant circuitry.

Also, the processor 110 may identify a band tune code that is valid for each of the first frequency band to the third frequency band, among the plurality of valid tune codes VTCs.

For example, the first frequency band may be referred to as a frequency band of less than about 1 GHz. For example, the second frequency band may be referred to as a frequency band of about 1 GHz or more to less than about 2 GHz. For example, the third frequency band may be referred to as a frequency band of about 2.3 GHz or more to less than 3 GHz. However, each frequency band is not limited to the above examples.

For example, the processor 110 may identify band tune codes satisfying band rules set for each frequency band, among the plurality of valid tune codes VTCs.

The processor 110 according to an example embodiment may identify first band tune codes BTC1s that are valid for the first frequency band, among the plurality of valid tune codes VTCs.

The processor 110 may identify the first band tune codes BTC1s satisfying the first band rule set for the first frequency band, among the plurality of valid tune codes VTCs.

According to an example embodiment, the first band rule may include a (1-1)th band rule set for bits corresponding to the first capacitor array CAD1.

The processor 110 may identify the first band tune codes BTC1s satisfying the (1-1)th band rule set for bits corresponding to the first capacitor array CAD1, among the plurality of valid tune codes VTCs.

The (1-1)th band rule may include, wherein the first capacitor code, including bits corresponding to the first capacitor array CAD1, has a value equal to or greater than a first lower limit code.

For example, the (1-1)th band rule may include, wherein the first capacitor code has a value equal to or greater than a first lower limit code such that the first capacitor array CAD1 has a capacitance equal to or greater than a first lower limit value set for the first frequency band.

For example, the (1-1)th band rule may include, wherein the first capacitor code, including the twelfth bit e12 to the fifteenth bit e15, has a value of “1000” or greater. For example, the processor 110 may determine that a tune code having a first capacitor code of “1010,” among the plurality of valid tune codes VTCs, satisfies the (1-1)th band rule.

According to an example embodiment, the first band rule may include a (1-2)th band rule set for bits corresponding to the third capacitor array CAD3.

The processor 110 may identify first band tune codes BTC1s satisfying a (1-2)th band rule set for bits corresponding to the third capacitor array CAD3, among the plurality of valid tune codes VTCs.

The (1-2)th band rule may include, wherein the third capacitor code composed of bits corresponding to the third capacitor array CAD3 has a value equal to or greater than a first lower limit code.

For example, the (1-2)th band rule may include, wherein the first capacitor code has a value equal to or greater than a first lower limit code such that the third capacitor array CAD3 has a capacitance equal to or greater than a first lower limit value set for the first frequency band.

For example, a (1-3)th band rule may include that a third capacitor code, including the twentieth bit e20 to the twenty-third bit e23, has a value of “1000” or greater. For example, the processor 110 may determine that a tune code having a third capacitor code of “1001,” among the plurality of valid tune codes VTCs, satisfies the (1-2)th band rule.

According to an example embodiment, the first band rule may further include an inductor rule in which at least one of the bits corresponding to the switches connected to the inductor (for example, the fifth switch SWD5, the ninth switch SWD9, and the tenth switch SWD10) has a first value (for example, “0”).

For example, the first band rule may further include an inductor rule in which at least one of the fifth bit e5, ninth bit e9, and tenth bit e10 corresponding to the switches connected to the inductor has “0.”

For example, the processor 110 may identify first band tune codes BTC1s in which at least one of the fifth bit e5, ninth bit e9, and tenth bit e10 has a value of “0,” the first capacitor code has a value of “1000” or greater, and the third capacitor code has a value of “1000” or greater, among the plurality of valid tune codes VTCs.

Also, the processor 110 according to an example embodiment may identify second band tune codes BTC2s that are valid for the second frequency band, among the plurality of valid tune codes VTCs.

The processor 110 according to an example embodiment may identify second band tune codes BTC2s satisfying the second band rule set for the second frequency band, among the plurality of valid tune codes VTCs.

The processor 110 may identify second band tune codes BTC2s satisfying the second band rule set for bits corresponding to the first capacitor array CAD1 and the second capacitor array CAD2, among the plurality of valid tune codes VTCs.

The second band rule may include a (2-1)th band rule in which the first capacitor code has a value equal to or greater than a second lower limit code smaller than the first lower limit code.

For example, the second band rule may include a (2-1)th band rule in which the first capacitor code has a value equal to or greater than a second lower limit code corresponding to a second lower limit value such that the first capacitor array CAD1 has a capacitance equal to or greater than a second lower limit value smaller than the first lower limit value.

For example, the (2-1)th band rule may include that the first capacitor code, including the twelfth bit e12 to the fifteenth bit e15, has a value of “0100” or greater. For example, the processor 110 may determine that a tune code having a first capacitor code of “0110,” among the plurality of valid tune codes VTCs, satisfies the (2-1)th band rule.

According to an example embodiment, the second band rule may include a (2-2)th band rule in which the second capacitor code has a value less than or equal to a first upper limit code. The second capacitor code may be understood as a code including bits corresponding to the second capacitor array CAD2, among the plurality of bits e1 to e23.

For example, the second band rule may include a (2-2)th band rule in which the second capacitor code has a value less than or equal to a first upper limit code corresponding to a first upper limit value such that the second capacitor array CAD2 has a capacitance less than or equal to the first upper limit value.

For example, the (2-2)th band rule may include that the second capacitor code, including the sixteenth bit e16 to the nineteenth bit e19, has a value less than “1000.” For example, the processor 110 may determine that a tune code having a second capacitor code of “0100,” among the plurality of valid tune codes VTCs, satisfies the (2-2)th band rule.

The processor 110 may identify second band tune codes BTC2s satisfying the second band rule set for bits corresponding to the first capacitor array CAD1 and the second capacitor array CAD2, among the plurality of valid tune codes VTCs.

The second band rule may include a second-3 band rule in which the third capacitor code has a value equal to or greater than a second lower limit code smaller than the first lower limit code.

For example, the second band rule may include a (2-3)th band rule in which the third capacitor code has a value equal to or greater than a second lower limit code corresponding to a second lower limit value such that the third capacitor array CAD3 has a capacitance equal to or greater than a second lower limit value smaller than the first lower limit value.

For example, the (2-3)th band rule may include, wherein the third capacitor code, including the twentieth bit e20 to the twenty-third bit e23, has a value of “0100” or greater. For example, the processor 110 may determine that a tune code having a third capacitor code of “0111,” among the plurality of valid tune codes VTCs, satisfies the (2-3)th band rule.

For example, the processor 110 may identify second band tune codes BTC2s in which the first capacitor code has a value of “0100” or greater, the second capacitor code has a value less than “1000,” and the third capacitor code has a value of “0100” or greater, among the plurality of valid tune codes VTCs.

Also, the processor 110 according to an example embodiment may identify third band tune codes BTC3s that are valid for the third frequency band, among the plurality of valid tune codes VTCs.

The processor 110 may identify third band tune codes BTC3s satisfying the third band rule set for the third frequency band, among the plurality of valid tune codes VTCs.

According to an example embodiment, the third band rule may include a (3-1)th band rule set for bits corresponding to the first capacitor array CAD1.

The processor 110 may identify third band tune codes BTC3s satisfying the third-1 band rule set for bits corresponding to the first capacitor array CAD1, among the plurality of valid tune codes VTCs.

A (3-1)th band rule may include, that the first capacitor code has a value equal to or greater than a third lower limit code smaller than the second lower limit code.

For example, the (3-1)th band rule may include, that the first capacitor code has a value equal to or greater than a third lower limit code corresponding to a third lower limit value such that the first capacitor array CAD1 has a capacitance equal to or greater than a third lower limit value smaller than the second lower limit value.

For example, the (3-1)th band rule may include, that the first capacitor code, including the twelfth bit e12 to the fifteenth bit e15, has a value of “0010” or greater. For example, the processor 110 may determine that a tune code having a first capacitor code of “0011,” among the plurality of valid tune codes VTCs, satisfies the (3-1)th band rule.

According to an example embodiment, the third band rule may include a (3-2)th band rule set for bits corresponding to the third capacitor array CAD3.

The processor 110 may identify third band tune codes BTC3s satisfying the (3-2)th band rule set for bits corresponding to the third capacitor array CAD3, among the plurality of valid tune codes VTCs.

A (3-2)th band rule may include, that the third capacitor code has a value equal to or greater than a third lower limit code smaller than the second lower limit code.

For example, the (3-2)th band rule may include, that the third capacitor code has a value equal to or greater than a third lower limit code corresponding to a third lower limit value such that the third capacitor array CAD3 has a capacitance equal to or greater than a third lower limit value smaller than the second lower limit value.

For example, the (3-2)th band rule may include, that the third capacitor code, including the twentieth bit e20 to the twenty-third bit e23, has a value of “0010” or greater. For example, the processor 110 may determine that a tune code having a third capacitor code of “0011,” among the plurality of valid tune codes VTCs, satisfies the (3-2)th band rule.

The third band rule may include, that each of the bits b16 to b16 corresponding to the second capacitor array CAD2 has a value of “0.”

For example, the processor 110 may identify second band tune codes BTC2s in which the first capacitor code has a value of “0010” or greater, the third capacitor code has a value of “0010” or greater, and the second capacitor code is “0000,” among the plurality of valid tune codes VTCs.

According to an example embodiment, the electronic device 100 may further include a memory storing the first band rule, the second band rule, and the third band rule. Furthermore, the memory may store the first band tune codes BTC1s, the second band tune codes BTC2s, and the third band tune codes BTC3s.

The processor 110 may control the tuning circuit 120D using one of the band tune codes identified for each frequency band when the electronic device 100 transmits and receives an RF signal of a predetermined frequency band through the antenna 130.

According to an example embodiment, the processor 110 may select one of the first band tune codes BTC1s when the electronic device 100 transmits and receives an RF signal of a first frequency band through the antenna 130.

For example, the processor 110 may select one of the first band tune codes BTC1s based on a reflection coefficient measured from the antenna 130 when the electronic device 100 transmits and receives the RF signal of the first frequency band through the antenna 130

According to an example embodiment, the processor 110 may select one of the second band tune codes BTC2s when the electronic device 100 transmits and receives an RF signal of a second frequency band through the antenna 130.

For example, the processor 110 may select one of the second band tune codes BTC2s based on the reflection coefficient measured from the antenna 130 when the electronic device 100 transmits and receives the RF signal of the second frequency band through the antenna 130

According to an example embodiment, the processor 110 may select one of the third band tune codes BTC3s when the electronic device 100 transmits and receives an RF signal of a third frequency band through the antenna 130.

For example, the processor 110 may select one of the third band tune codes BTC3s based on the reflection coefficient measured from the antenna 130 when the electronic device 100 transmits and receives the RF signal of the third frequency band through the antenna 130.

Furthermore, the processor 110 may control the tuning circuit 120D using the selected tune code.

Referring to the above-described configurations, the processor 110 may identify a plurality of band tune codes BTC1s, BTC2s, and BTC3s that are valid for each frequency band, among the plurality of valid tune codes VTCs, based on the pre-stored band rules corresponding to each frequency band.

Furthermore, the processor 110 may control the tuning circuit 120D using one of the plurality of band tune codes BTC1s, BTC2s, and BTC3s identified for each frequency band depending on the frequency band of the RF signal transmitted and received through the antenna 130.

As a result, the electronic device 100 according to an example embodiment may reduce the time and costs required to select a valid tune code depending on the frequency band.

Referring to the above-described configurations, the electronic device 100 may prevent the tuning circuit 120D from being controlled by tune codes invalid for each frequency band.

As a result, the electronic device 100 according to an example embodiment may significantly reduce the degradation of performance of transmitting and receiving RF signals through the antenna 130.

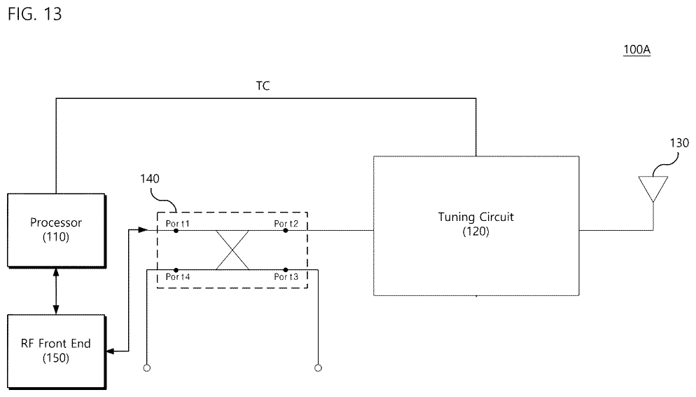

FIG. 13 is a diagram illustrating an electronic device further including a coupler according to an example embodiment.

Referring to FIG. 13, an electronic device 100A according to an example embodiment may include a processor 110, a tuning circuit 120, an antenna 130, an RF front end 150 and a coupler 140.

The electronic device 100A illustrated in FIG. 13 may be understood as an example of the electronic device 100 illustrated in FIG. 1. Therefore, the same or substantially the same components are represented by the same reference numerals, and redundant descriptions will be omitted to avoid repetition.

According to an example embodiment, the electronic device 100A may further include a coupler 140 connected between a processor 110 and a tuning circuit 120.

For example, the electronic device 100A may include a coupler 140 transmitting a signal, transmitted from the processor 110, through the RF front end 150 to the antenna 130 or transmitting a signal, reflected from the antenna 130, to the processor 110 through the RF front end 150.

As shown in FIG. 13, the coupler 140 may be implemented as a bidirectional coupler. For example, the coupler 140 may be implemented as a bidirectional coupler including a first port port1 to a fourth port port4.

According to an example embodiment, the coupler 140 may output a signal, input through the first port port1, through the third port port3. As a result, the coupler 140 may transmit a signal, output from the processor 110, to the antenna 130 through the tuning circuit 120.

Also, the coupler 140 may output a signal, input through the second port port2, through the fourth port port4. As a result, the coupler 140 may transmit a signal, reflected from the antenna 130, to the processor 110.

According to an example embodiment, the processor 110 may calculate a reflection coefficient depending on a frequency of the signal transmitted and received through the antenna 130 based on the signal received through the coupler 140.

Furthermore, the processor 110 may select a single band tune code, among band tune codes identified for each frequency band, based on the calculated reflection coefficient. Also, the processor 110 may control the tuning circuit 120 using the selected tune code.

According to an example embodiment, the processor 110 may select a single first band tune code, among first band tune codes BTC1s, based on the reflection coefficient measured through the coupler 140 when the electronic device 100 transmits and/or receives an RF signal of a first frequency band through the antenna 130.

According to an example embodiment, the processor 110 may select a single second band tune code, among second band tune codes BTC2s, based on the reflection coefficient measured through the coupler 140 when the electronic device 100 transmits and/or receives an RF signal of the second frequency band through the antenna 130.

According to an example embodiment, the processor 110 may select a single third band tune code, among third band tune codes BTC3s, based on the reflection coefficient measured through the coupler 140 when the electronic device 100 transmits and/or receives an RF signal of the third frequency band through the antenna 130.

Furthermore, the processor 110 may control the tuning circuit 120 using the selected tune code. For example, the processor 110 may control a plurality of elements of the tuning circuit 120, each corresponding to a bit, depending on a plurality of bits included in the selected tune code.

Referring to the above-described configurations, the processor 110 may calculate the reflection coefficient of the signal transmitted and received through the antenna 130 using the coupler 140.

Furthermore, the processor 110 may select one of the plurality of band tune codes BTC1s, BTC2s, and BTC3s identified for each frequency band based on the calculated reflection coefficient and control the tuning circuit 120.

As a result, the electronic device 100 according to an example embodiment may reduce the time and costs required to select a valid tune code depending on the frequency band.

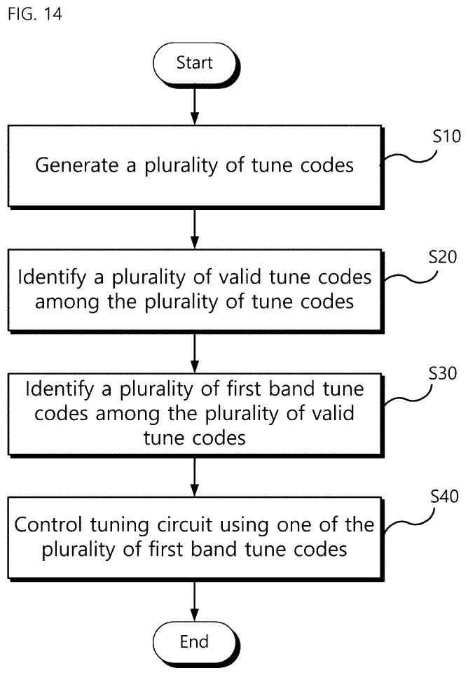

FIG. 14 is a flowchart illustrating a method of controlling a tuning circuit according to an example embodiment.

Referring to FIG. 14, the processor 110 (or the electronic device 100) according to an example embodiment may identify valid tune codes for each frequency band, among a plurality of tune codes TCas, based on information on the tuning circuit 120.

For example, the processor 110 may identify a plurality of band tune codes BTC1s, BTC2s, BTC3s that are valid depending on the frequency band, among the plurality of tune codes TCas for controlling the tuning circuit 120, based on information related to the tuning circuit 120 and prestored rules.

Furthermore, the processor 110 may control the tuning circuit 120 using at least a portion of the identified tune codes.

In operation S10, the processor 110 according to an example embodiment may generate and output a plurality of tune codes TCas.

For example, the processor 110 may generate a plurality of tune codes TCas including a plurality of bits b1 to b14 for controlling a plurality of elements included in the tuning circuit 120, based on information related to the plurality of elements included in the tuning circuit 120.

For example, information on the plurality of elements included in the tuning circuit 120 may include first information including an arrangement and a connection relationship of the plurality of elements.

For example, the information on the plurality of elements included in the tuning circuit 120 may include second information on an element corresponding to each of the plurality of bits b1 to b14, among the plurality of elements.

Accordingly, the processor 110 may generate and output a plurality of tune codes TCas based on at least a portion of the first information and the second information.

Each of the plurality of bits b1 to b14 may have a value of “0” or “1” represent in binary. Therefore, for example, when the tune code TCa includes 15 bits, the processor 110 may generate 2¹⁵-1 tune codes TCas.

In operation S20, the processor 110 according to an example embodiment may identify a plurality of valid tune codes VTCs, among the plurality of tune codes TCas.

For example, the processor 110 may identify a plurality of valid tune codes VTCs satisfying prestored default rules, among the plurality of tune codes TCas.

The default rule according to an example embodiment may include a first default rule in which a first bit b1 has a predetermined first value (for example, “1”). For example, the default rule may include a first default rule in which a first bit b1 corresponding to the first switch SWA1 has a predetermined first value (for example, “1”).

The first switch SWA1 may be understood as a switch connected to the antenna 130 within the tuning circuit 120A. For example, when the first switch SWA1 is turned off, an electrical path connected from the processor 110 (through the RF front end 150) to the antenna 130 may be interrupted.

Also, the default rule may include a second default rule in which a third bit b3 has a predetermined value when the second bit b2 has a second value.

For example, the default rule may include a second default rule in which a third bit b3 corresponding to the third switch SWA3 has a predetermined value (for example, “0”) when a second bit b2 corresponding to the second switch SWA2 has a second value (for example, “0”).

The second switch SWA2 and the third switch SWA3 may be connected in series between the processor 110 and the ground. For example, when the second switch SWA2 is in an OFF state, the operation of the third switch SWA3 may not affect the electrical path connected from the processor 110 (through the RF front end 150) to the antenna 130.

Also, the default rule may include a third default rule in which the twelfth bit b12 to the fifteenth bit b15 have a predetermined value when the fourth bit b4 has a second value.

For example, the default rule may include a third default rule in which an eleventh bit b11 to a fourteenth bit b14 corresponding to a second capacitor array CAA2 have a predetermined value (for example, “0”) when a fourth bit b4 corresponding to the fourth switch SWA4 has a first value (for example, “0”).

The fourth switch SWA4 and the second capacitor array CAA2 may be connected in series between the processor 110 and the ground. For example, when the fourth switch SWA4 is in an OFF state, the capacitance of the second capacitor array CAA2 may not affect the electrical path connected from the processor 110 (through the RF front end 150) to the antenna 130.

Also, the default rule may include a fourth default rule in which the sixth bit b6 to the tenth bit b10 have a predetermined value when the fifth bit b5 has a first value (for example, “1”).

For example, the default rule may include a fourth default rule in which the sixth bit b6 to the tenth bit b10 corresponding to the first capacitor array CAA1 have a predetermined value (for example, “0” when the fifth bit b5 corresponding to the fifth switch SWA5 has a first value (for example, “1”).

A fifth switch SWA5 and a first capacitor array CAA1 may be connected in parallel. For example, when the fifth switch SWA5 is in an ON state, the capacitance of the first capacitor array CAA1 may not affect the electrical path connected from the processor 110 (through the RF front end 150) to the antenna 130.

According to an example embodiment, the processor 110 may identify a plurality of valid tune codes VTCs satisfying all of the first default rule to the fourth default rule, among the plurality of tune codes TCas.

For example, the processor 110 may identify a first valid tune code VTC1 “10100000000000” satisfying all of the first default rule to the fourth default rule, among the plurality of tune codes TCas.

As a result, for example, the processor 110 may identify 1200 valid tune codes VTCs satisfying all of the first default rule to the fourth default rule, among the 2¹⁵-1 tune codes TCas.

Referring to the above-described configurations, the processor 110 may identify a plurality of valid tune codes VTCs, among a plurality of tune codes TCas for controlling the tuning circuit 120, based on information related to the tuning circuit 120A and prestored default rules.

For example, the processor 110 may identify a plurality of valid tune codes VTCs other than tune codes interrupting the valid electrical path from the processor 110 (through the RF front end 150) to the antenna 130 or having redundant circuitry.

As a result, the electronic device 100 according to an example embodiment may significantly reduce the time and costs required for impedance matching due to tune codes interrupting the valid electrical path or having redundant circuitry.

In operation S30, the processor 110 according to an example embodiment may identify first band tune codes BTC1s that are valid for the first frequency band, among the plurality of valid tune codes VTCs.

For example, the processor 110 may identify first band tune codes BTC1s satisfying the first band rule set for the first frequency band, among the plurality of valid tune codes VTCs.

The processor 110 may identify first band tune codes BTC1s satisfying the first band rule set for bits corresponding to the first capacitor array CAA1, among the plurality of valid tune codes VTCs.

The first band rule may include, that the first capacitor code, including the first capacitor bits (for example, the sixth bit b6 to the tenth bit b10) corresponding to the first capacitor array CAA1 has a value greater than or equal to a first lower limit code.

For example, the first band rule may include, that the first capacitor code has a value greater than or equal to a first lower limit code corresponding to a first lower limit value such that the first capacitor array CAA1 has a capacitance greater than or equal to a first lower limit value set for the first frequency band.

For example, the processor 110 may determine that a tune code having a first capacitor code of “10000” or greater satisfies the first band rule.

According to an example embodiment, the first band rule may further include an inductor rule in which at least one of the bits corresponding to the switches (for example, the second switch SWA2, the third switch SWA3, and the fifth switch SWA5) connected to the inductor has a first value (for example, “0”).

For example, the first band rule may further include an inductor rule in which at least one of the values of the second bit b2, the third bit b3, and the fifth bit b5 corresponding to the switches connected to the inductor is “0.”

For example, the processor 110 may identify first band tune codes BTC1s in which at least one of the values of the second bit b2, the third bit b3, and the fifth bit b5 is “0” and the first capacitor code has a value of “10000” or greater, among the plurality of valid tune codes VTCs.

For example, the processor 110 may identify a tune code “10100010000000” satisfying the first band rule as one of the first band tune codes BTC1s, among the plurality of valid tune codes VTCs.

In operation S40, the processor 110 according to an example embodiment may control the tuning circuit 120 using one of the first band tune codes BTC1s.

For example, the processor 110 may control the tuning circuit 120 using one of the first band tune codes BTC1s when the electronic device 100 transmits and receives an RF signal of the first frequency band through the antenna 130.

The processor 110 may select a single first band tune code, among the first band tune codes BTC1s, based on the reflection coefficient measured from the antenna 130 when the electronic device 100 transmits and receives an RF signal of the first frequency band through the antenna 130.

Furthermore, the processor 110 may control the tuning circuit 120 using the selected tune code.

Referring to the above-described configurations, the processor 110 may identify a plurality of first band tune codes BTC1s that are valid for the first frequency band, among the plurality of valid tune codes VTCs, based on the first band rule pre-stored corresponding to the first frequency band.

Furthermore, the processor 110 may control the tuning circuit 120 using one of the plurality of first band tune codes BTC1s.

As a result, the electronic device 100 according to an example embodiment may reduce the time and costs required to select a valid tune code depending on the frequency band.

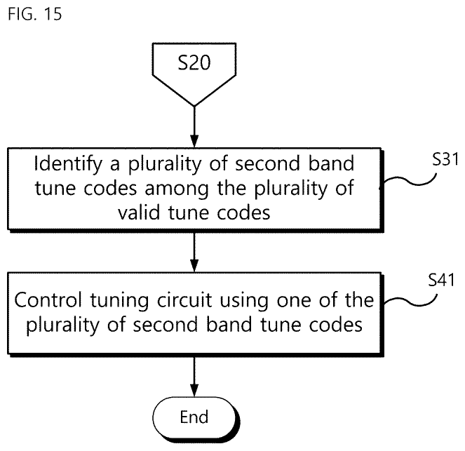

FIG. 15 is a flowchart illustrating a method of controlling a tuning circuit based on a plurality of second band tune codes valid for a second frequency according to an example embodiment.

Referring to FIG. 15, the processor 110 according to an example embodiment may identify a plurality of second band tune codes BTC2s that are valid for the second frequency band. Furthermore, the processor 110 may control the tuning circuit 120 using one of the plurality of second band tune codes BTC2s.

In operation S31, the processor 110 according to an example embodiment may identify a plurality of second band tune codes BTC2s that are valid for the second frequency band, among the plurality of valid tune codes VTCs.

For example, the processor 110 may identify second band tune codes BTC2s satisfying the second band rule set for the second frequency band, among the plurality of valid tune codes VTCs.

The processor 110 may identify second band tune codes BTC2s satisfying the second band rule set for bits corresponding to the first capacitor array CAA and the second capacitor array CAA2, among the plurality of valid tune codes VTCs.

The second band rule according to an example embodiment may include a (2-1)th band rule in which the first capacitor code corresponding to the first capacitor array CAA1 has a value greater than or equal to a second lower limit code smaller than the first lower limit code.

For example, the second band rule may include a (2-1)th band rule in which the first capacitor code has a value greater than or equal to a second lower limit code corresponding to a second lower limit value such that the capacitance of the first capacitor array CAA1 has a value greater than or equal to a second lower limit value that is smaller than the first lower limit value.

For example, the processor 110 may determine that a tune code having a first capacitor code of “01000” or greater satisfies the (2-1)th band rule.

Also, the second band rule according to an example embodiment may include a (2-2)th band rule in which the second capacitor code has a value less than or equal to a first upper limit code.

For example, the second band rule may include a (2-2)th band rule in which the second capacitor code has a value less than or equal to a first upper limit code corresponding to a first upper limit value such that the capacitance of the second capacitor array CAA2 has a value less than or equal to a first upper limit value.

For example, the processor 110 may determine that a tune code having a second capacitor code of less than “1000” satisfies the (2-2)th band rule.

For example, the processor 110 may identify second band tune codes BTC2s in which the first capacitor code has a value of “01000” or greater and the second capacitor code has a value of less than “1000,” among the plurality of valid tune codes VTCs.

For example, the processor 110 may identify a tune code “10100001000000” satisfying the second band rule as one of the second band tune codes BTC2s, among the plurality of valid tune codes VTCs.

In operation S41, the processor 110 according to an example embodiment may control the tuning circuit 120 using one of the second band tune codes BTC2s.

For example, the processor 110 may control the tuning circuit 120 using one of the second band tune codes BTC2s when the electronic device 100 transmits and receives an RF signal of a second frequency band through the antenna 130.

The processor 110 may select one of the second band tune codes BTC2s based on a reflection coefficient, measured from the antenna 130, when the electronic device 100 transmits and receives the RF signal of the second frequency band through the antenna 130.

Furthermore, the processor 110 may control the tuning circuit 120 using the selected tune code.

Referring to the above-described configurations, the processor 110 may identify a plurality of second band tune codes BTC2s that are valid for the second frequency band, among the plurality of valid tune codes VTCs, based on the second band rule prestored to correspond to the second frequency band.

Furthermore, the processor 110 may control the tuning circuit 120 using one of the plurality of second band tune codes BTC2s.

As a result, the electronic device 100 according to an example embodiment may reduce the time and costs required to select a valid tune code depending on a frequency band.

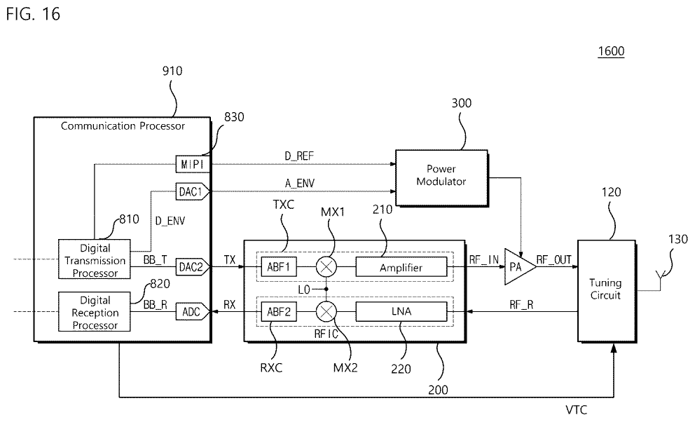

FIG. 16 is a block diagram of an electronic device according to an example embodiment.

Referring to FIG. 16, a wireless communication device 1600 according to an example embodiment may include a communication processor 910, a radio-frequency integrated circuit (RFIC) 200, a power modulator 300, a tuning circuit 120, a power amplifier PA, and an antenna 130.

The wireless communication device 1600 and the configuration thereof illustrated in FIG. 16 may be understood as examples of the electronic device 100 and the configuration thereof illustrated in FIG. 1, respectively. Therefore, the same or substantially the same components are represented by the same reference numerals, and redundant descriptions will be omitted to avoid repetition.

The communication processor 910 may process a baseband signal BB_T using a predetermined communication scheme through an internal digital transmission processor 810. The communication processor 910 may also process a received baseband signal BB_R using the predetermined communication scheme through a digital reception processor 820.

For example, the communication processor 910 may process a signal to be transmitted or a received signal using a communication scheme such as orthogonal frequency division multiplexing (OFDM), orthogonal frequency division multiplexing access (OFDMA), wideband code a plurality of access (WCDMA), or high speed packet access+ (HSPA+). In addition, the communication processor 910 may process the baseband signal BB_T or BB_R using various types of communication schemes (for example, various communication schemes to which a technique of modulating or demodulating the amplitude and frequency of the baseband signal BB_T or BB_R is applied).

The communication processor 910 may extract an envelope of the baseband signal BB_T through the digital transmission processor 810 and generate a digital envelope signal D_ENV based on the extracted envelope. Also, the communication processor 910 may generate an average power signal D_REF based on the average power tracking table stored in a memory. The extracted envelope may correspond to an amplitude component of the baseband signal BB_T (for example, magnitudes of an I signal and a Q signal).

The communication processor 910 may perform digital-to-analog conversion on each of the baseband signal BB_T and the digital envelope signal D_ENV using a plurality of digital-to-analog converters DA C1 and DA C2 provided therein to generate a transmit signal TX and an analog envelope signal A_ENV that are analog signals. For example, the average power signal D_REF output from the communication processor 910 may be a digital signal. Accordingly, the average power signal D_REF may be provided in the digital-to-analog converter provided in the power modulator 300 through a mobile industry processor interface (MIPI) 830, and may be converted into an analog signal, such as a reference voltage signal, through the digital-to-analog converter provided in the power modulator 300. For example, the digital-to-analog converters DAC1 and DAC2 provided in the communication processor 910 may operate at a relatively high speed compared to the digital-to-analog converter provided in the power modulator 300.

However, example embodiments are not limited thereto, and the communication processor 910 may convert the average power signal D_REF into an analog signal through the digital-to-analog converter provided therein and output the analog signal. The communication processor 910 may provide the average power signal, converted into the analog signal, to the power modulator 300 as a reference voltage signal.

For ease of description, an example will be provided in which the communication processor 910 provides the average power signal D_REF to the digital-to-analog converter provided in the power modulator 300 through the MIPI 830.

The transmit signal TX and the analog envelope signal A_ENV may be differential signals, each including a positive signal and a negative signal.

Also, the communication processor 910 may also receive a receive signal RX, an analog signal, from the RFIC 200. Also, the communication processor 910 may convert the receive signal RX into a digital signal through an analog-to-digital converter (ADC) provided therein to extract a baseband signal BB_R as a digital signal. The receive signal RX may be a differential signal including a positive signal and a negative signal.

The RFIC 200 may generate an RF input signal RF_IN by performing up-conversion on the transmit signal TX or generate a receive signal RX by performing down-conversion on an RF receive signal RF_R. For example, the RFIC 200 may include a transmission circuit TXC for up-conversion, a reception circuit RXC for down-conversion, and a local oscillator LO.

The transmission circuit TXC may include a first analog baseband filter ABF1, a first mixer MX1, and an amplifier 210. For example, the first analog baseband filter ABF1 may include a low pass filter.

The first analog baseband filter A BF1 may filter the transmit signal TX received from the communication processor 910 and provide the transmit signal TX to the first mixer MX1. Also, the first mixer MX1 may perform up-conversion, converting a frequency of the transmit signal TX from a baseband to a high-frequency band, through a frequency signal provided by the local oscillator LO. Through the up-conversion, the transmit signal TX may be provided to the amplifier 210 as an RF input signal RF_IN, and the amplifier 210 may amplify the RF input signal RF_IN firstly and provide the amplified RF input signal to the power amplifier PA.

The power amplifier PA may receive a power supply voltage (for example, a dynamically variable output voltage) from the power modulator 300 and generate an RF output signal RF_OUT by amplifying power of the RF input signal RF_IN secondly based on the supplied power supply voltage. Also, the power amplifier PA may provide the generated RF output signal RF_OUT to the tuning circuit 120.

The reception circuit RX C may include a second analog baseband filter ABF2, a second mixer MX2, and a low-noise amplifier 220. For example, the second analog baseband filter ABF2 may include a low pass filter.

The low-noise amplifier 220 may amplify the RF receive signal RF_R provided from the tuning circuit 120 and provide the amplified RF receive signal to the second mixer MX2. Also, the second mixer MX2 may perform down-conversion, converting a frequency of the receive signal RF_R from a high frequency band to a baseband, through the frequency signal provided by the local oscillator LO. Through the down-conversion, the RF received signal RF_R may be provided as a receive signal RX to the second analog baseband filter ABF2, and the second analog baseband filter A BF2 may filter the receive signal RX and provide the filtered receive signal to the communication processor 910.

The wireless communication device 1600 may transmit a transmit signal through a plurality of frequency bands using carrier aggregation (CA). To this end, the wireless communication device 1600 may include a plurality of power amplifiers amplifying a plurality of RF input signals RF_IN, respectively corresponding to the plurality of carriers. For ease of description, an example is provided in which there is only one power amplifier PA.

The power modulator 300 may generate a modulated output voltage having a level varying dynamically based on the analog envelope signal A_ENV and the average power signal D_REF, and may provide the modulated output voltage as a power supply voltage to the power amplifier PA.

For example, the power modulator 300 may receive the average power signal D_REF and the analog envelope signal A_ENV from the communication processor 910. Also, the power modulator 300 may generate an output voltage, which is dynamically variable, driven by either ET mode or APT mode based on the provided average power signal D_REF and the analog envelope signal A_ENV. Also, the power modulator 300 may supply the generated output voltage as a power supply voltage to the power amplifier PA.

When a fixed level of power supply voltage is applied to the power amplifier PA, the power efficiency of the power amplifier PA may be reduced. Accordingly, the power modulator 300 may efficiently manage the power of the power amplifier PA by modulating an input voltage (for example, power supplied from a battery) based on at least one of the analog envelope signal A_ENV and the average power signal D_REF and providing the modulated voltage as a power supply voltage to the power amplifier PA.

The tuning circuit 120 may dynamically adjust internal impedance under the control of the processor 110 to significantly reduce signals reflected from the antenna 130.

For example, the tuning circuit 120 may include an impedance tuner (or an impedance matching circuit) and/or an aperture tuner. The aperture tuner may be formed as a component of the antenna 130.

The wireless communication device 1600 may be provided with a duplexer, which may separate a transmission frequency and a reception frequency, instead of the tuning circuit 120. For example, the duplexer may separate the RF output signal RF_OUT, provided from the power amplifier PA, for each frequency band and provide the separated RF output signal to the corresponding antenna 130. Also, the duplexer may provide an external signal, provided from the antenna 130, to the low-noise amplifier 220 of the reception circuit RXC of the RFIC 200. For example, the duplexer may include a front end module with integrated duplexer (FEMiD).

The antenna 130 may transmit the RF output signal RF_OUT to the outside or provide the RF receive signal RF_R, received from the outside, to the RFIC 200. For example, the antenna 130 may include an array antenna, but example embodiments are not limited thereto.

The communication processor 910, the power modulator 300, the RFIC 200, the power amplifier PA, and the tuning circuit 120 may be implemented as individual ICs, chips, or modules. Also, the communication processor 910, the power modulator 300, the RFIC 200, the power amplifier PA, and the tuning circuit 120 may be mounted together on a printed circuit board (PCB). However, example embodiments are not limited thereto. In some embodiments, at least a portion of the communication processor 910, the power modulator 300, the RFIC 200, the power amplifier PA, and the tuning circuit 120 may be implemented as a single communication chip.

Furthermore, the wireless communication device 1600 illustrated in FIG. 16 may be included in a wireless communication system using a cellular network such as 5G or LTE, and may also be included in a wireless local area network (WLAN) system or other arbitrary wireless communication systems. Note that the configuration of the wireless communication device 1600 illustrated in FIG. 16 is only an example, and example embodiments are not limited thereto. The wireless communication device 1600 may be configured in various manners depending on a communication protocol or a communication method.

The communication processor 910 illustrated in FIG. 16 may be understood as an example of the processor 110 illustrated in FIG. 1.

According to an example embodiment, the communication processor 910 may identify a plurality of valid tune codes VTCs, among a plurality of tune codes TCs for controlling the tuning circuit 120, based on information related to the tuning circuit 120 and prestored default rules.

For example, the communication processor 910 may identify a plurality of valid tune codes VT Cs, other than tune codes interrupting a valid electrical path or having redundant circuitry, and may output the valid tune codes VTCs to the tuning circuit 120.

Furthermore, the communication processor 910 may identify a plurality of valid band tune codes BTC1s, BTC2s, and BTC3s for each frequency band, among the plurality of valid tune codes VTCs, based on prestored band rules corresponding to each frequency band.

Furthermore, the communication processor 910 may control the tuning circuit 120 using one of the band tune codes identified for each frequency band, based on the frequency band of the RF signal transmitted or received through the antenna 130.

As a result, the wireless communication device 1600 according to an example embodiment may reduce the time and costs required to select valid tune codes depending on a frequency band.

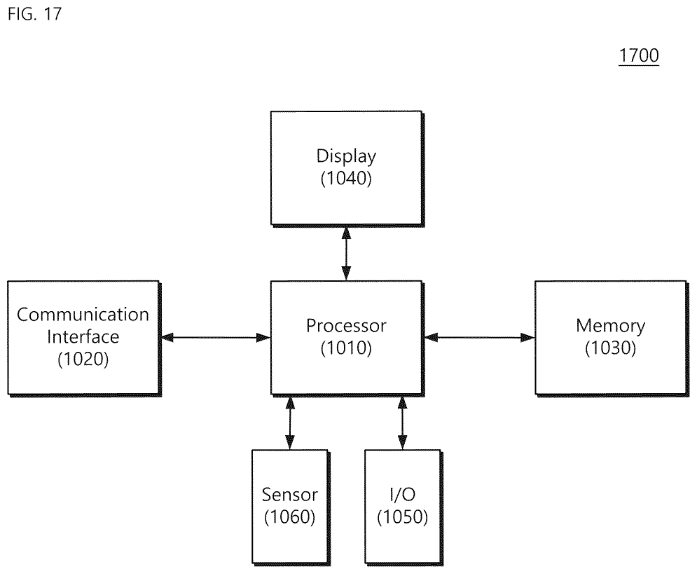

FIG. 17 is a block diagram of an IoT device including an electronic device according to an example embodiment.

Referring to FIG. 17, Internet of Things (IoT) may refer to a network between things using wired communication and/or wireless communication. An IoT device 1700 may have accessible wired or wireless interfaces and may include device transmitting or receiving data by communicating with at least one other device through the wired or wireless interfaces. The accessible interfaces of the IoT device 1700 may include a wired local area network (LAN), a wireless local area network (WLAN) such as Wi-Fi, a wireless personal area network (WPAN) such as Bluetooth, wireless universal serial bus (USB), Zigbee, near field communication (NFC), radio-frequency identification (RFID), power line communication (PCL), or modem communication interfaces that may be connected to a mobile cellular network such as 3G, LTE, 4G, or 5G. The Bluetooth interface may support Bluetooth low energy (BLE).

For example, the IoT device 1700 may include a communication interface 1020 for communicating with external devices. The communication interface 1020 may be, for example, a wired LAN interface, a wireless LAN interface such as Bluetooth, Wi-Fi, Zigbee, a PLC, or a modem communication interface that may be connected to a mobile network such as 3G, LTE, 4G, or 5G.

The IoT device 1700 according to an example embodiment may be understood to include substantially the same configuration as the electronic device 100 illustrated in FIG. 1.

The communication interface 1020 may include a transmitter and/or receiver. The communication interface 1020 illustrated in FIG. 17 may be understood to include the antenna 130 illustrated in FIG. 1.

The IoT device 1700 may transmit and/or receive information from an access point or a gateway through the transmitter and/or receiver. In addition, the IoT device 1700 may communicate with a user device or another IoT device to transmit and/or receive control information or data of the IoT device 1700.

The IoT device 1700 may include a processor 1010 performing operations. The processor 1010 illustrated in FIG. 17 may be referenced as having substantially the same configuration as the processor 110 illustrated in FIG. 1.

According to an example embodiment, the processor 1010 may identify a plurality of valid tune codes VTCs, among a plurality of tune codes TCas for controlling the tuning circuit 120, based on information related to the tuning circuit 120 and prestored default rules.

For example, the processor 1010 may identify a plurality of valid tune codes VTCs, other than tune codes interrupting a valid electrical path or having redundant circuitry.

In addition, the processor 1010 may identify a plurality of band tune codes BTC1s, BTC2s, BTC3s that are valid for each frequency band, among a plurality of valid tune codes VTCs, based on prestored band rules corresponding to each frequency band.

Furthermore, the processor 1010 may control the tuning circuit 120 using one of the band tune codes identified for each frequency band, based on the frequency band of the RF signal transmitted or received through the antenna 130.

As a result, the IoT device 1700 according to an example embodiment may reduce the time and costs required to select valid tune codes for each frequency band.

The IoT device 1700 may further include a power supply that incorporates a battery for internal power supply or receives power from the outside. In addition, the IoT device 1700 may include a display 1040 displaying an internal state or data. A user may control the IoT device 1700 through a user interface UI of the display 1040 of the IoT device 1700. The IoT device 1700 may transmit the internal state and/or data to the outside through the transmitter, and may receive control a command and/or data from the outside through the receiver.

The memory 1030 may store control a command code, control data, or user data for controlling the IoT device 1700. The memory 1030 may include at least one of a volatile memory and a nonvolatile memory. The nonvolatile memory may include at least one of various types of memory such as read-only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (ReRAM), or a ferroelectric RAM (FRAM). The volatile memory may include at least one of various types of memory such as a dynamic RAM (DRAM), a static RAM (SRAM), or a synchronous DRAM (SDRAM).

According to an example embodiment, the memory 1030 may store information related to a plurality of elements included in the tuning circuit 120. In addition, the memory 1030 may store information (or data) on default rules that are set for at least a portion of bits corresponding to the plurality of elements included in the tuning circuit 120.

Furthermore, the memory 1030 may store information (or data) on band rules (for example, first band rule, second band rule, and third band rule) corresponding to each frequency band. Also, the memory 1030 may store the band tune codes BTC1s, BTC2s, BTC3s identified for each frequency band.

In addition, the memory 1030 may store the first band rule, the second band rule, and the third band rule, which are set for the first frequency band, second frequency band, and third frequency band, respectively.

The IoT device 1700 may further include a storage device. The storage device may include at least one of nonvolatile media such as a hard disk (HDD), a solid-state drive (SSD), an embedded multimedia card (eMMC), or a universal flash storage (UFS). The storage device may store user information provided through an input/output (I/O) unit and sensing information collected through the sensor 1060.

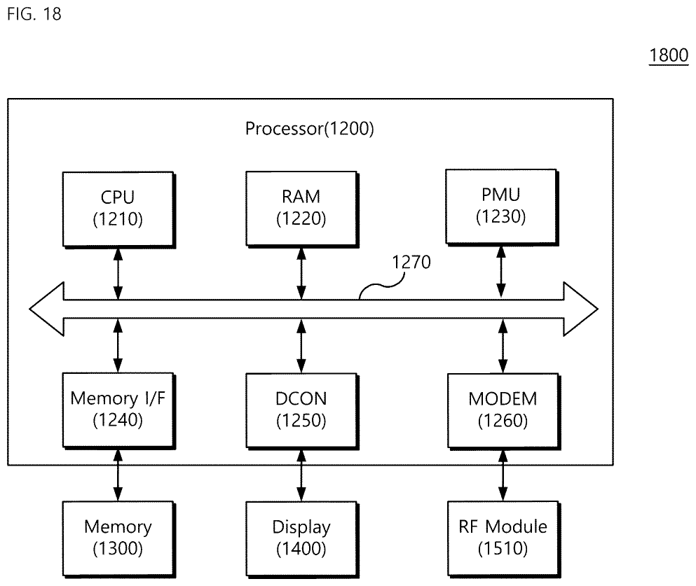

FIG. 18 is a block diagram of a mobile terminal to which an electronic device according to an example embodiment is applied.

Referring to FIG. 18, a mobile terminal 1800 may include a processor 1200, a memory 1300, a display 1400, and a radio-frequency (RF) module 1510. The mobile terminal 1800 may further include various components such as a lens, a sensor, or an audio module.

The processor 1200 may be implemented as a system-on-chip (SoC), and may include a central processing unit (CPU) 1210, a RAM 1220, a power management unit (PMU) 1230, a memory interface (Memory I/F) 1240, a display controller (DCON) 1250, a modem 1260, and a bus 1270. The processor 1200 may also include various other intellectual properties (IPs). Functions of a modem chip are integrated into the processor 1200, so that the processor 1200 may be referred to as a modem application processor (ModAP), but example embodiments are not limited thereto.

The processor 1200 illustrated in FIG. 18 may be referenced as having substantially the same configuration as the processor 110 illustrated in FIG. 1.

The CPU 1210 may control the overall operation of the processor 1200 and the mobile terminal 1800. The CPU 1210 may control the operation of each component of the processor 1200. In addition, the CPU 1210 may be designed with a multicore architecture. The multicore architecture includes a single computing component with two or more independent cores.

The RAM 1220 may temporarily store programs, data, or instructions. For example, programs and/or data stored in memory 1300 may be temporarily stored in the RAM 1220 under the control of the CPU 1210 or based on a booting code. The RAM 1220 may be implemented as a DRAM or an SRAM.

The PMU 1230 may manage the power of each component of the processor 1200. Also, the PMU 1230 may determine an operating status of each component of the processor 1200 and control an operation thereof.

The memory interface 1240 may control the overall operation of memory 1300 and may control data exchange between each component of the processor 1200 and the memory 1300. The memory interface 1240 may write data in the memory 1300 or read data from the memory 1300 based on a request of the CPU 1210.

The display controller 1250 may transmit image data to be displayed on the display 1400 to the display 1400. The display 1400 may be implemented as a flat panel display such as a liquid crystal display (LCD) or an organic light-emitting diode (OLED), or as a flexible display.

The modem 1260 may modulate data to be transmitted to be appropriate to a wireless environment and recover received data. The modem 1260 may perform digital communication with the RF module 1510.

The RF module 1510 may convert a high-frequency signal received through the antenna 130 into a low-frequency signal and transmit the converted low-frequency signal to the modem 1260. In addition, the RF module 1510 may convert the low-frequency signal, received from the modem 1260, into a high-frequency signal and transmit the converted high-frequency signal to the outside of the mobile terminal 1800 through the antenna. The RF module 1510 may amplify or filter signals.

According to an example embodiment, the processor 1200 may identify a plurality of valid tune codes VTCs, among a plurality of tune codes TCAs for controlling the tuning circuit 120, based on information related to the tuning circuit 120 and prestored default rules.

For example, the processor 1200 may identify a plurality of valid tune codes VTCs, other than tune codes interrupting a valid electrical path or having redundant circuitry.

In addition, the processor 1200 may identify a plurality of valid band tune codes BTC1s, BTC2s, and BTC3s for each frequency band, among the plurality of valid tune codes VTCs, based on pre-stored band rules corresponding to each frequency band.

Furthermore, the processor 1200 may control the tuning circuit 120 using one of the band tune codes identified for each frequency band from among the plurality of band tune codes BTC1s, BTC2s, and BTC3s based on the frequency band of the RF signal transmitted or received through the antenna 130.

As a result, the mobile terminal 1800 according to an example embodiment may reduce the time and costs required to select valid tune codes based on the frequency band.

As described above, the processor 110 according to an example embodiment may identify a plurality of valid tune codes VTCs, among a plurality of tune codes TCAs for controlling the tuning circuit 120, based on information related to the tuning circuit 120 and prestored default rules.

For example, the processor 110 may identify a plurality of valid tune codes VTCs, other than tune codes interrupting a valid electrical path or having redundant circuitry.

As a result, the electronic device 100 according to an example embodiment may significantly reduce the time and cost required for impedance matching caused by the tune codes interrupting a valid electrical path or having redundant circuitry.

Furthermore, the processor 110 according to an example embodiment may identify a plurality of valid band tune codes BTC1s, BTC2s, and BTC3s for each frequency band, among the plurality of valid tune codes VTCs, based on prestored band rules corresponding to each frequency band.

Moreover, the processor 110 may control the tuning circuit 120 using one of the band tune codes identified for each frequency band, among the plurality of band tune codes BTC1s, BTC2s, and BTC3s, based on the frequency band of the RF signal transmitted or received through the antenna 130.

As a result, the electronic device 100 according to an example embodiment may reduce the time and costs required to select valid tune codes based on the frequency band.

As set forth above, an electronic device according to example embodiments may reduce time and costs required to select effective tune codes depending on frequency.

While example embodiments have been shown and described above, it will be apparent to those skilled in the art that modifications and variations could be made without departing from the scope of the present inventive concept as defined by the appended claims.

What is claimed is:

1. An electronic device comprising:
an antenna configured to transmit and/or receive a radio-frequency (RF) signal;
a tuning circuit connected to the antenna and comprising a plurality of elements; and
a processor configured to control the tuning circuit using a tune code comprising a plurality of bits, respectively corresponding to the plurality of elements,
wherein the processor is configured to:
identify a plurality of valid tune codes from among a plurality of tune codes having different values, based on information related to the plurality of elements, the plurality of valid tune codes satisfying a predetermined default rule for at least a portion of the plurality of bits;
identify a plurality of first band tune codes from among the plurality of valid tune codes, the plurality of first band codes satisfying a first band rule set for bits corresponding to at least one capacitor array; and
control the tuning circuit using one of the plurality of first band tune codes when the electronic device transmits and/or receives a signal of a first frequency band, the first frequency band being different from at least one other frequency band at which the processor controls the tuning circuit using different ones of the plurality of identified valid tune codes.

2. The electronic device of claim 1, wherein:
the plurality of elements comprise a plurality of switches; and
the default rule comprises:
a first default rule in which a first bit among the plurality of bits, and corresponding to a first switch connected to the antenna, has a predetermined first value; and
a second default rule in which a third bit corresponding to a third switch connected to the second switch has a predetermined value when a second bit corresponding to a second switch has a second value different from the first value.

3. The electronic device of claim 2, wherein
the tune code comprises a first capacitor code comprising first capacitor bits corresponding to a first capacitor array among the plurality of bits, and
the first band rule comprises, that the first capacitor code has a value greater than or equal to a first lower limit code corresponding to a first lower limit value set for the first frequency band such that the first capacitor array has a capacitance greater than or equal to the first lower limit value.

4. The electronic device of claim 3, wherein the processor is configured to:
identify a plurality of second band tune codes satisfying a second band rule set for the first capacitor bits, among the plurality of valid tune codes; and
control the tuning circuit using one of the plurality of second band tune codes when the electronic device transmits and/or receives a signal of a second frequency band greater than the first frequency band through the antenna, and
the second band rule comprises a (2-1)th band rule in which the first capacitor code has a value greater than or equal to a second lower limit code corresponding to a second lower limit value smaller than the first lower limit value such that the first capacitor array has a capacitance greater than or equal to the second lower limit value.

5. The electronic device of claim 4, wherein:
the tune code comprises a second capacitor code comprising second capacitor bits corresponding to a second capacitor array among the plurality of bits, and
the second band rule comprises a (2-2)th band rule in which the second capacitor code has a value less than a first upper limit code corresponding to a first upper limit value such that the second capacitor array has a capacitance less than the first upper limit value.

6. The electronic device of claim 5, wherein the default rule further comprises a third default rule in which the second capacitor bits have predetermined values when a fourth bit corresponding to a fourth switch connected to the second capacitor array has the second value.

7. The electronic device of claim 1, wherein the default rule further comprises an invalid default rule in which an invalid bit corresponding to an invalid element electrically separated from an electrical path connected from the processor to the antenna, among the plurality of bits, has a predetermined value.

8. The electronic device of claim 1, further comprising:
a coupler connected between the tuning circuit and the processor,
wherein the processor determines a tune code for controlling the tuning circuit, among the plurality of first band tune codes, based on a reflection coefficient measured through the coupler when the electronic device transmits and/or receives the signal of the first frequency band through the antenna.

9. The electronic device of claim 1, wherein:
information related to the plurality of elements comprises first information, comprising an arrangement and a connection relationship of the plurality of elements, and second information on an element, corresponding to each of the plurality of bits, among the plurality of elements, and
the processor generates the plurality of tune codes based on at least a portion of the first information and the second information.

10. The electronic device of claim 2, wherein the first band rule further comprises an inductor rule in which at least one bit corresponding to at least one switch connected to at least one inductor, among the plurality of switches, has the first value.

11. A method of controlling a tuning circuit, the method comprising:
generating a plurality of tune codes, each comprising a plurality of bits corresponding to a plurality of elements included in the tuning circuit, based on a number of the plurality of elements;
identifying a plurality of valid tune codes satisfying a default rule set for at least some of the plurality of bits, from among the plurality of tune codes;
identifying a plurality of first band tune codes, satisfying a first band rule set for bits corresponding to at least one capacitor array, from among the plurality of valid tune codes; and
controlling the tuning circuit using one of the plurality of first band tune codes when a signal of a first frequency band is transmitted and/or received through an antenna, the first frequency band being different from at least one other frequency band at which the tuning circuit operates using different ones of the identified plurality of valid tune codes.

12. The method of claim 11, wherein
the default rule comprises:
a first default rule in which a first bit corresponding to a first switch connected to the antenna has a predetermined first value, among the plurality of bits; and
a second default rule in which a third bit has a predetermined value when a second bit, among the plurality of bits, has a second value different from the first value.

13. The method of claim 12, wherein
each of the plurality of tune codes comprises a first capacitor code comprising first capacitor bits corresponding to a first capacitor array, among the plurality of bits, and
the first band rule comprises, that the first capacitor code has a value greater than or equal to a first lower limit code corresponding to a first lower limit value such that the first capacitor array has a capacitance greater than or equal to the first lower limit value.

14. The method of claim 13, further comprising:
identifying a plurality of second band tune codes satisfying a second band rule set for the first capacitor bits from among the plurality of valid tune codes; and
controlling the tuning circuit using one of the plurality of second band tune codes when a signal of a second frequency band greater than the first frequency band is transmitted and received through the antenna,
wherein,
the second band rule comprises, that the first capacitor code has a value greater than or equal to a second lower limit code corresponding to a second lower limit value lower than the first lower limit value such that the first capacitor array has a capacitance greater than or equal to the second lower limit value.

15. The method of claim 11, wherein
the controlling the tuning circuit using one of the plurality of first band tune codes further comprises:
determining a tune code for controlling the tuning circuit, among the plurality of first band tune codes, based on a reflection coefficient measured through a coupler connected to the antenna when the signal of the first frequency band is transmitted and received through the antenna.

16. An antenna device comprising:
a tuning circuit comprising a plurality of elements; and
a processor configured to control the tuning circuit using a tune code comprising a plurality of bits, respectively corresponding to the plurality of elements,
wherein the processor is configured to:
identify a plurality of valid tune codes satisfying a default rule set for at least a portion of the plurality of bits from among a plurality of tune codes having different values, based on information related to the plurality of elements; and
control the tuning circuit using one of the plurality of valid tune codes.

17. The antenna device of claim 16, wherein:
the plurality of elements comprise a plurality of switches, and
the default rule comprises:
a first default rule in which a first bit corresponding to a first switch connected to the antenna has a predetermined first value, among the plurality of bits; and
a second default rule in which a third bit has a designated value when a second bit, among the plurality of bits, has a second value different from the first value.

18. The antenna device of claim 16, further comprising:
an antenna connected to the tuning circuit and configured to transmit and/or receive a radio-frequency (RF) signal,
wherein the processor is configured to:
identify a plurality of first band tune codes satisfying a first band rule set for bits corresponding to at least one capacitor array from among the plurality of valid tune codes; and
control the tuning circuit using one of the plurality of first band tune codes when a signal of a first frequency band is transmitted and/or received through the antenna.

19. The antenna device of claim 18, wherein
the tune code comprises a first capacitor code comprising first capacitor bits, corresponding to a first capacitor array, among the plurality of bits, and
the first band rule comprises, wherein the first capacitor code has a value greater than or equal to a first lower limit code corresponding to a first lower limit value such that the first capacitor array has a capacitance greater than or equal to the first lower limit value.

20. The antenna device of claim 16, wherein:
information related to the plurality of elements comprises first information, comprising an arrangement and a connection relationship of the plurality of elements, and second information on an element, corresponding to each of the plurality of bits, among the plurality of elements, and
the processor generates the plurality of tune codes based on at least a portion of the first information and the second information.
